(19) United States
(12) Patent Application Publication
(10) Pub. No.: US 2025/0035300 A1
(43) Pub. Date: Jan. 30, 2025

(54) Smart LED Luminaires for Safety Systems

(71) Applicants: Wes Fannin, Greenville, WI (US); Michael Toth, Tremont, MI (US)

(72) Inventors: Wes Fannin, Greenville, WI (US); Michael Toth, Tremont, MI (US)

(21) Appl. No.: 18/916,573

(22) Filed: Oct. 15, 2024

Related U.S. Application Data
(63) Continuation-in-part of application No. 18/374,572, filed on Sep. 28, 2023, now Pat. No. 12,169,055.
(60) Provisional application No. 63/459,504, filed on Apr. 14, 2023.
(60) Provisional application No. 63/453,650, filed on Mar. 21, 2023.
(60) Provisional application No. 63/469,341, filed on May 26, 2023.
(60) Provisional application No. 63/466,162, filed on May 12, 2023.

(51) Int. Cl. F21V 33/00; F21Y 115/10; G08B 7/06; G08B 13/16; G08B 15/02; G08B 17/08; G08B 21/02; G08B 25/00; G08B 27/00

(52) U.S. Cl. CPC F21V 33/0076; F21V 33/0056; G08B 7/066; G08B 13/1672; G08B 15/02; G08B 17/08; G08B 21/02; G08B 25/009; G08B 27/001; F21Y 2115/10

(57) ABSTRACT

A smart lighting system is described in which an array of smart luminaires such as LED luminaires forms a network, each luminaire comprising a microphone, a power source or driver, and a network communication device. The system is configured such that in response to a sound indicative of a dangerous incident such as a gunshot, the network conveys information to a command center to raise alerts about the dangerous incident, and the system in turn directs the network to modify its light output in order to assist the evacuation of individuals in the building or to assist in mitigation of the threat posed by the dangerous incident. Other countermeasures can be implemented as well.

### FIELD OF THE DISCLOSURE

The present disclosure pertains to safety systems in which LED luminaires or other luminaires combine with networks or other systems to detect and respond to various threats in order to enhance safety, particularly in or near buildings.

### CROSS-REFERENCE TO RELATED APPLICATIONS

This application claims priority to U.S. patent application Ser. No. 18/374,572, “LED Luminaire With Improved Updating and Replacement Characteristics,” filed Sep. 28, 2023, which in turn claims priority to the following: U.S. Provisional Patent Application Ser. No. 63/459,504, “LED Luminaires for Safety Systems,” filed Apr. 14, 2023; U.S. Provisional Patent Application Ser. No. 63/453,650, “LED Luminaire Replacement and Retrofit Units,” filed Mar. 21, 2023; U.S. Provisional Patent Application Ser. No. 63/466,162, “Universal LED Drivers,” filed May 12, 2023; and U.S. Provisional Patent Application Ser. No. 63/469,341, “Mobile Networks and Smart Luminaires for Safety Systems,” filed May 26, 2023, all of which are hereby incorporated by reference in their entirety.

### BACKGROUND

There are growing safety risks in our communities due to violent crime and the misuse of weapons such as guns. While systems have been proposed that detect gunfire or the use of weapons with sound sensors, for example, there is a need for systems that can not only detect a threat, but actively assist in coping with the threat. There is also a need to provide improved accuracy in locating the source of a threat. Further, there is a need for enhanced safety and response systems that can be easily installed into existing infrastructure at low cost, rather than requiring costly new installations of hardware to be installed within a facility, and, in some cases, that can take advantage of networks of mobile devices. (The solutions described herein may address one or more of these needs, but it should be understood that no single aspect of any invention described must necessarily satisfy any one or all of the enumerated needs.)

### SUMMARY

An array of smart or active LED luminaires is provided in which the LED luminaires comprise sensors, or are electrically connected to sensors, that can detect one or more indications of a threat to safety such as gunshots or other emergencies or hazards (e.g., acts of violence such as gunshots, verbal aggression, an explosion, a crash of a vehicle or other object, a fall, the collapse or toppling of a structure, overcrowding that may pose a stampede or crushing threat, a fire, structural damage from an earthquake or other cause, intrusion of unauthorized personnel, intrusion by animals, the spread of harmful gases or other chemicals, the breaking of glass or the forced opening of an entrance during illegal entry, etc.).

Applicant has found that an effective system for detecting safety threats and, in many aspects, for also responding to safety threats can be provided using an array of luminaires such as LED elements in troffers or otherwise suspended from a ceiling or, more generally, provided in multiple locations, typically elevated, in a building or other setting. In one aspect, existing luminaires are modified to provide at least one sensor and a communication device such that the modified luminaire can share information from the sensor with a network such as a mesh network or with a command center.

One or more sensors and/or one or more communication devices may be connected to or in electrical communication with the luminaire, and in particular with the component chassis of the luminaire. For example, a sensor and a communication device may be integrated into an LED component chassis that can be easily installed in a luminaire, or may be electrically connected or joined by wire, cable, or similar conductive means to the component chassis or particularly to the LED driver. For example, a sensor such as a camera or motion detector may be installed on a suitable location on the luminaire where it is not covered or obstructed by the lens, and yet be electrically connected to the component chassis that is largely or entirely covered by the lens when the lens is in place. A wire or cable may provide the electrical connection to the sensor as well as to the communication device. Likewise, a sensor or a communication device may also be installed near the luminaire but not directly on the luminaire, and yet still be electrically connected to the luminaire via a wire, cable, or other conductive means that may, for example, provide both power and conveyance of data. Of course, the luminaire may also be in wireless communication with various sensors near the luminaire or remote from the luminaire.

Sensors may be attached to the component chassis such that they are covered or partly covered by the lens, when in place, but may also be mounted on surfaces of the luminaire that are not covered or completely covered by the lens. Sensors may also be attached to an edge of the lens or may be mounted on a surface of the lens to have an unimpeded line of sight to objects or people below, or may be protrude at least in part through an opening in the lens such as a hole or have line of sight through such a hole, if desired. Further, a sensor may be electrically connected to the luminaire (e.g., to the LED driver or component chassis) but not be physically present on the luminaire, but may be remote such as on or behind an adjacent ceiling tile or embedded in or disposed on other materials near the luminaire, thus providing added flexibility regarding the placement of a sensor. Such sensors may detect noise, muzzle flashes, the motion of people including evidence of physical assault, various chemicals or other materials, fire, non-traditional weaponry, air quality (including detection of particulate levels or ionization levels that may be an indication of gun shots, fire, or other concerns), vibration, motion, etc. Metal detectors, muzzle flash detectors, and other related sensors may also be employed to provide safety-related information. Other devices may be connected by wire or wirelessly connected for a variety of other purposes including the delivering of countermeasures to confuse, distract, deter, or impede an assailant or other threat.

In some aspects, the smart LED luminaire comprises a modular component chassis which enables rapid addition of sensors or other components, rapid upgrading of the LED driver or communication device, etc., such that the system can be easily upgraded or in, some aspects, that needed components can be easily installed as an upgrade to LED luminaires already equipped with modular component chassis, such as those described in co-pending U.S. Ser. No. 18/374,572, filed Sep. 28, 2023, by Wes Fannin et al., hereby incorporated by reference in its entirety. Such modular component chassis thus may be adapted to receive sensors and a communication device, for example, without the need to remove the entire luminaire or to access the backside of the luminaire frames in order to make connections and install components. Rather, in some aspects, such components may be attached without the need for tools and without the need to remove the frame or to access the backside of the frame, for the component chassis itself can be readily removed from its position within a frame to allow upgrades or additions of components on either side of the component chassis to be made. In some aspects, the component chassis is adapted to remain engaged with the frame along one side while an opposing side of the component chassis is detached from the frame and may, in some aspects, hang therefrom, allowing a worker to readily access both sides of the component chassis to make needed changes and upgrades, as described in U.S. Ser. No. 18/374,572. Such a modular component chassis system makes it possible for improved technology and advanced controls to be installed easily without the high expense normally associated with changes to LED lighting systems.

In one aspect, connections for various sensors may be provided on both sides of the component chassis or its substrate or may be accessible on both sides of a luminaire, allowing the sensors to be installed by attaching cables to the back or the front of a luminaire or its component chassis for flexibility in updating luminaires with respect to the protective or other functions of the smart lighting network.

In a related aspect, the luminaires may be further modified to also comprise a driver or other controller that can receive commands from the network or command center (e.g., via the communication device) to cause the luminaire to take actions to assist humans in the vicinity in properly responding to the threat.

The actions may include changes in light intensity or color such that the array of luminaires shows humans what areas to avoid (e.g., darkened regions or regions with flashing red lights) or provides guidance about escape routes to follow (e.g., by defining a pathway with green lights, or by having strips or arrays of individual LED lights turn on and off in sequence to create moving cues showing a direction to travel). Thus, in many aspects, the LED luminaires not only assist in detecting a hazard and precisely locating it, but also serve a valuable role in guiding evacuation or otherwise assisting humans and reducing harm from the hazard.

The network may also include other devices that need not be directly wired to or be physically on or near a luminaire such as security cameras, motion detectors, load cells, IR sensors, accelerometers, gunshot sensors, RFID readers, etc., that are adapted to communicate with the lighting network. In some aspects, more than one communication device may be present on one or more luminaires. In some aspects, the communication device (or communication devices) operates on two distinct bands or participates on two distinct networks, such as a lighting network to communicate information related to the performance and control of lighting, and an emergency network to share information directly related to an emergency such as gunshot data, location information regarding an assailant, information regarding injuries, risk assessment data, etc. Mesh networks or other networks may be used. In another aspect, the lighting network and/or emergency network may include outdoor devices such as smart outdoor LED lighting fixtures or microphones, etc. In a related aspect, the lighting network and/or emergency network may include both indoor devices such as luminaires and outdoor devices such as exterior LED fixtures or luminaires, microphones, cameras, gunshot detectors, etc., and may comprise gunshot identification systems described herein. In such aspects, a gunshot outside of a building may result in immediate defensive actions within the building as information about the exterior threat is conveyed to a command center to guide rapid actions before an assailant enters a building. Video tools coupled with AI may also be used outside as well as inside a building to provide an early indication of potential gun use, such as by visually identifying a gun being carried to identify gait, stance, and behavior related to aggression and possible gun use to identity a potential assailant in order to prevent entry into a building and take other preventative measures as the video or other sensors (including metal detectors in some cases) identify a potential threat. Video information may also provide warnings about dangers or assailants other than gunshots, such as intruders that may be using knives, chemical weapons, lasers, fire, and so forth. Such information can be communicated to the command center and to a smart lighting network that can assist in prevention, risk mitigation, and in guiding people away from danger.

In one aspect, a safety system is provided that employs one or more wireless networks such as telecom networks of mobile devices (e.g., a distributed network) to detect and actively respond to safety threats with the aid of a command center (e.g., a central server in communication with the network or networks of the safety system and suitable software modules, databases, and communication tools) and suitable software for the command center to interact with the mobile devices as needed. The command center, for example, may have or be in communication with a central server equipped with data processing modules, real-time analytics tools, decision making modules, and communication channels for emergency response coordination and reporting to various authorities, services, personnel, parents, etc. The safety system may also comprise one more other networks such as mesh networks of smart lighting devices or other devices in a building such as a school, mall, or church or other public place such as a sports field or public square. The safety system is adapted to rapidly detect gunshots or other threats to safety in a protected region, and to track the location of the threat. Further, the system is adapted to assist people in the vicinity to escape or otherwise enhance their safety, and may also guide, direct, or assist in taking countermeasures to directly mitigate the threat.

In some aspects, a safety system is provided that is adapted to detect danger inside a building as well as outside the building. In such as aspect, an interior gunshot detection or danger detection system may be present, as well as an exterior gunshot detection system that may include a plurality of smart external LED fixtures that cooperate with a plurality of sensors such as gunshot detectors, microphones, video cameras, motion detectors, etc., configured to communicate with the command center and to detect an exterior threat. The command center may in response consider interior as well as exterior risks from detected threats to recommend actions to be taken in response, such as guiding people away from exits near an exterior threat and/or taking other appropriate actions to obtain help and reduce risk, including the use of selected countermeasures.

In some aspects, a smart lighting network and a mobile device network both cooperate and communicate with a command center to facilitate at least one of the group consisting of detecting a gunshot, tracking the location of an assailant (suspected or known), guiding people in the vicinity to safety, and taking countermeasures to mitigate a threat. “In the vicinity” can refer to being physically located in a region or facility protected by the safety system, or to a specific portion of the that region such as a portion relatively near the site of a dangerous incident or other hazard, such as within 200 meters, 100 meters, or 50 meters from the site of a hazard.

In some aspects, the building or, more generally, the protected region provides a public network such as a Wi-Fi network that offers users the option or requirement to participate in a safety function of the network wherein a mobile device is used for one or more safety functions such as: (1) applying one or more sensors (e.g., a microphone, light meter, camera, accelerometer, particulate sensors, etc., which may be integrated with a mobile device or fixed device such as a smart LED luminaire) to detect indications of a gunshot or other hazard; (2) sharing information relevant to a potential hazard (e.g., a recording of microphone or other sensor data, data from or derived by processing an audio signal or other measured signal such as accelerometer data or optical indications of muzzle flash, etc.) with a command center or a network; (3) providing guidance to people in the facility to guide them to safety (e.g., escaping from the area, finding a relatively safe location, giving alerts about the potential approach of an assailant, etc.); (4) assisting in rescue and emergency medical care operations (e.g., serving as “eyes” or “ears”-cameras or microphones—to help paramedics or others understand needs and locations where emergency attention is needed); and (5) assisting with countermeasures against a hazard (e.g., serving as beacons, “eyes” or “ears” to help direct security forces, first responders, automated drones, vehicles, robots, etc. to a needed location). By accepting the offer or the requirement for use of the local Wi-Fi service or other incentives for participating, any needed software modules (e.g., APIs, browser extensions, plug ins, or other tools) for effective communication with the command center or for making the mobile device available for gunshot detection or other safety-related functions, the user may thereby grant permission for the installation of software on the mobile device and/or for making selected data from the mobile device available for analysis by the network or the associated command center.

Strict privacy controls may be in place that only permit sharing or recording data that meets certain criteria indicative of being a gunshot or other hazard. For example, the privacy rules for the system may specify that only when an acoustic signal exceeds a threshold in sound pressure such as at least 75, 80, 85, 90, or 95 dB and, if desired, also meets one or more additional criteria indicative of a gunshot (e.g., reverberation criteria, frequency characteristics, sound decay rate, spectral characteristics obtained from FFT analysis, etc.) can the acoustic data from a mobile device be “listened to” by the safety system or otherwise shared with the safety system or others through the safety system. In one aspect, for example, a data cache on the mobile device is continually recording sound from, say, the last 3 to 10 seconds such that when a loud event is determined to be a potential gunshot, the acoustic data from several seconds before the determination has been made may be made available with the apparent gunshot signal as well to ensure that the relevant acoustic data is saved and transmitted to, for example, the command center, making it fully available for further analysis and sharing with appropriate parties. In this way, the nature of the event can be further ascertained or confirmed and next steps can be determined with greater confidence.

In some aspects, a smart lighting network of LED luminaires or other smart lighting systems is adapted to cooperate with a network of mobile devices to detect gunshots or other threats, and to take steps to mitigate such threats or to assist those in the vicinity.

The LED luminaires or smart luminaires in general may include a light source, a control system for regulating light output, a communication device such as one or more radios that may be operatively associated with the control system, and may optionally comprise or be connected to one or more sensors that may provide information relevant to safety.

LED lights may include any kind of LED light including lights based on traditional LED chips, OLEDs (organic LEDs), micro-LEDs, etc. LED lights may be in any format such as LED lights on a panel, in one or more strips, in a tube, in a bulb, or in format such as in a troffer, spot LED lights, flood LED lights, indirect or cove lighting, LED grid lights (e.g., narrow linear sections of LED lights that can surround ceiling tiles in a dropdown ceiling or form stand-alone light strips apart from ceiling tiles, including T-grid lights wherein strips of LED lights are superimposed directly on the suspended T-grid of a ceiling), etc. Nevertheless, smart lighting networks may comprise communication devices combined with other lighting technologies such as fluorescent tubes, compact fluorescent lamps (CFLs), incandescent bulbs, halogen bulbs, high-intensity discharge (HID) bulbs (e.g., metal halide, sodium, and mercury vapor), biolamps employing bioluminescence, quantum dot lighting, plasma lights, and hybrids of any two of more of these.

Such smart lighting networks generally comprise luminaires of any suitable shape and disposed in any suitable location (in a recessed ceiling, suspended from ceilings or other overhead structures, a wall panel, a cove, flooring, etc.). The luminaires generally have a power source (e.g., wires transmitting AC or DC power, batteries, induction power, solar power, etc.), a light source, a lighting control device such as a driver or ballast, and a communication device (e.g., one or more radios operating on one or more protocols and one or more bands) adapted to convey instructions from the command center or other source to the lighting control device and/or provide information about the luminaire and/or provide information about one or more sensors that may be attached to or otherwise in electrical or wireless communication with the luminaire (e.g., with its communication device or control device). In some aspects the communication device may be contained within or mounted on the control device.

The luminaires may comprise communication devices such as one or more radios operating on one or more wavelengths, and may comprise or be electrically connected to sensors, that can detect one or more indications of a threat to safety such as gunshots or other emergencies, threats, or hazards. Further, the smart lighting network may be adapted to interact with a mobile network to obtain higher resolution in locating an assailant or gunshot sources, information on injuries or medical emergencies, views of potential hazards outside of building, and so forth, and also to provide urgent information to people in the vicinity such as occupants of a building. Such cooperation may be achieved with the use of software that may reside in part on various servers and devices, such as in the cloud, in servers at a command center, on servers, computers and mobile devices using a Wi-Fi network, on servers, computers and mobile devices using a mobile network such as a 5G network, etc. Some of the software used in the system may be modules or APIs that are uploaded to individual mobile devices such as smartphones or other cell phones as such devices join a network and the users agree to the terms and conditions provided on order to join the network (e.g., to access Wi-Fi service or simply to assist in promoting safety, or for benefits or incentives that may be offered).

In some aspects, a mobile device in a region protected with a safety system as described herein may download or otherwise access or run a computer program product accessible from a computer-usable or computer-readable medium such as systems associated with a cell phone, computer, or computerized security system dashboard, and thereby obtain program code that can be executed by one or more processors associated with the mobile device or other computer-readable media or by processors elsewhere such as in the cloud that can communicate with the mobile device or other electronic systems. A computer-usable or computer-readable medium can be, for example, any apparatus adapted to store, execute, interact with, communicate, propagate, or transport the program for use by a processor or any instruction execution system, apparatus, or device including volatile and/or non-volatile memory, any writable or readable device, etc. The computer-usable medium may include a propagated data signal with the computer-usable program code embodied therewith transmitted via any appropriate medium such as a wireless network, Wi-Fi, 5G or 6G networks, optical fiber, cable, and the like.

In some aspects, a distributed mobile network comprising a plurality of mobile devices may be provided in a protected region, wherein the mobile devices are in communication with a command center, and adapted to share safety-related data with the command center such as loud sounds that could stem from a gunshot or other hazard and location information. The command center is also in communication with another network such as a fixed network comprising a smart lighting system and/or other devices such those in a BACnet or other facility network for a building or other facility. Information from the fixed network and the mobile network may be integrated for rapid and efficient identification of a threat, analysis of the threat (e.g., the type of gun and ammo used, number of guns, locations of assailants, and apparent paths being pursued by assailants), avoidance of the threat (e.g., evacuation directions, shelter-in-place directions, warnings about location of the assailant, instructions on how to prevent access to room, etc.), care for those injured (e.g., first aid instructions, guidance of emergency responders to those injured, providing information on nature of injuries and status of the injured, etc.), and assisting in deployment of countermeasures against the threat.

The emergencies, threats, or hazards that may be detected and in some aspects mitigated by the systems, methods, and devices described herein may include acts of violence such as gunshots, verbal aggression, an explosion, a crash of a vehicle or other object, a fall, the collapse or toppling of a structure, overcrowding that may pose a stampede or crushing threat, a fire, structural damage from an earthquake or other cause, intrusion of unauthorized personnel, intrusion by animals, the spread of harmful gases or other chemicals, the breaking of glass or the forced opening of an entrance during illegal entry, etc.).

In many aspects, the use of a suitable microphone to detect gunshots or other sounds associated with danger can play a valuable role in quickly responding to danger. For gunshot detection or other high-sound-pressure events, microphones can be adapted to detect sounds and consider them as potential gunshot sounds for sound pressure values around 90 or 95 decibels, near the range that might occur with a suppressed .22 caliber gun, and/or ranges greater than 120 decibels (dB), considering that roughly 130 to 140 dB may be a common range for low-caliber guns, and going up to, for example, 170 to 180 dB or more for more powerful guns. Thus, in one aspect, a module for detection of a gunshot may be activated when a sound pressure greater than 90 dB, 95 dB, or 100 dB is encountered, though in some aspects as sound pressure of about 115 dB or 120 dB may be required. Peak sound pressure may be measured over a suitable time frame such as 200 microseconds, or 1, 3, 5, or 10 milliseconds. Any suitable microphone can be used for this purpose, such as MEMS microphones, condenser microphones including electret condenser microphones, or dynamic microphones. One example of a MEMS microphone is the VM2020 MEMS microphone marketed by Vesper Technologies (Boston, MA), which is an omnidirectional, differential output piezoelectric MEMS microphone with a high acoustic overload point (AOP), the point at which distortion begins (more specifically, when Total Harmonic Distortion or THD begins to exceed 10% at 1 kHz), said to be 152 dB, making it generally suitable for sound intensities of 170 dB or higher. Examples of condenser microphones include a Brüel & Kjaer (Naerum, Denmark) 4165 condenser microphone cartridge (0.5 inch diameter) or several of the series from types 4133 to 4181 with diameters of 0.5 inches, 0.25 inches, or 0.125 inches, having frequency ranges from 2.6 Hz to 140 kHz, dynamic ranges from −34 dB to 180 dB SPL, and choice of pressure, random or free-field response. CMC electret microphones of CUI Devices (Tualatin, OR) with an AOP of 130 dB or higher may also be considered, by way of example.

Such microphones can be small (e.g., having a diameter less than 30 mm, 25 mm, 20 mm, or 15 mm, or, in the case of MEMS microphones, for example, having no dimension greater than 15 mm, 10 mm, or 6 mm, such as a size smaller than 7 mm×6 mm×4 mm, or smaller than 4 mm×3 mm×2 mm) and can readily be installed at one or more locations on a luminaire or adjacent to a luminaire. With more than one microphone, information about the location of a noise can be inferred using triangulation from the sounds recorded by a single luminaire, particularly when three or more microphones at different locations are accessed.

In one aspect, sound obtained exceeding a peak sound pressure level is stored to memory and analyzed by a suitable processor, and the memory and processor may be present in the driver or in electrical communication with the driver of a component chassis of an LED luminaire. This can also be done with the processor of a mobile device. The sound data or the results of the analysis can be sent to the command center for further action.

In another aspect, mobile devices such as cell phones are adapted to measure and record potentially relevant gunshot sounds (sounds that could be due to one or more gunshots, for example) and to communicate such recordings and/or measurements characterizing the sounds (e.g., decibel level or sound pressure characteristics, reverberation parameters, sound decay parameters, frequency information, etc.) to a command center or server via a network such as a mobile network or other distributed network or mesh network.

In some aspects, a network of smart luminaires cooperates with a network of mobile devices to provide a variety of information pertaining to noise, motion, location, etc., in order to assist a command center and/or a network in recognizing and tracking safety hazards, and in some aspects to further participate in coping with identified hazards. Coping may be achieved by, for example, providing direction to humans on how to seek safety; providing information about the nature of the risk to authorities or first responders, etc., so that they can take proper actions; assisting in guiding or carrying out countermeasures to help mitigate the risk, etc.

In general, an LED luminaire may take the form of a lighting unit or light fixture with one or more LED lights or LED panels. An LED luminaire may be in the form of a troffer having one or more LED lights. Each LED light may comprise a chip in cooperation with a phosphor that influences the color of the emitted light. The LED light may be capable of displaying various colors. Thus, it may be an RGB light, with a diode for each of red, green, and blue combined into the light, or it may be an RGBW LED light that comprise a dedicated white diode with diodes for red, green, and blue as well. The LED luminaire may also be used in wall panels, floor lights, stairwells, etc.

In one aspect, an LED luminaire is in the form of a troffer for installation in a ceiling, with the troffer connected to AC or DC power (including power over ethernet) and with the LED luminaire comprising a plurality of LED lights. The LED luminaire may comprise a driver that delivers current to the LED lights and controls not only the applied power or voltage, but also which lights are active or how bright individual lights are. In one version, for example, there may be a plurality of lights of a first color and a plurality of lights of a second color, with the number of lights of each color or the intensity of the lights of each color being controlled by the driver responsive to settings applied to the LED luminaire by various means such as control settings on the LED luminaire or associated with the LED luminaire, or applied remotely through, for example, a wired or wireless signal.

An LED luminaire may include, for example, a packaged light emitting device such as an LED panel or strip including one or more LED lights, which may include inorganic LEDs, which may include semiconductor layers forming p-n junctions and/or may include organic LEDs (OLEDs), which may include organic light emission layers. LED lights may be white LEDs with phosphors (lumiphors) of various color tones or temperatures but may also comprise a combination of colored LEDs such as red, green, and blue LEDs. Output color of such a device may be altered by separately adjusting the supply of current to the various LEDs. Another method for providing a desired type of light is to stimulate phosphors or dyes of multiple colors with an LED source.

The component chassis may also comprise or be associated with or connected to various sensors such as motion detectors, IR sensors, temperature sensors, brightness sensors, color sensors, cameras, RFID antennae and associated circuitry for reading RFID tags of any kind, antennae for detecting and transmitting other electromagnetic signals, Bluetooth systems, Wi-Fi systems, telecommunications systems such as 3G, 4G, 5G, and 6G systems, microphones, video cameras, accelerometers, radar systems, LIDAR units, ionization detectors, smoke detectors, humidity sensors, various gunshot detectors, etc. The component chassis may also comprise a microprocessor and a memory in order to receive, process, and transmit information such as signals based on data from sensors associated with the component chassis. Such sensors may be mounted on the substrate of the component chassis or may be mounted elsewhere on or near the frame of the luminaire but in communication with the microprocessor of the gear. Instructions for processing data or for regulating lights or other electronic devices may be stored in the memory. In some aspects, memory need not be mounted on the component chassis but may be remote to the component chassis as long as the component chassis is in communication with the memory.

The one or more LED lights in the LED luminaire may found in one or more LED panels (e.g., a strip or array), each of which comprises one or more LED lights (e.g., LED chips or cells). The LED lights may be arranged in a predetermined pattern on the strip or panel, and are electrically connected to the driver that may control the amount of current or voltage supplied to each LED light or to the LED panels. The driver may be configured to cooperate with one or more sensors to regulate the current and/or voltage supplied to the LED lights based on various factors, such as the desired brightness, color temperature, or color rendering index (CRI) of the LED luminaire, or in response to motion or the presence of humans and many other factors.

The LED panels or strips may be mounted on a heat sink or other suitable material in the substrate that provides thermal management for the LED lights in addition to providing structural support. The heat sink may be designed to dissipate heat generated by the LED lights, the LED driver, or other components, to promote longevity of the LED luminaire.

The LED luminaire or other luminaires may also include various optical components, such as lenses (which may also be diffusers), diffusers, or reflectors, that are positioned over or near the lights to control the direction and distribution of light emitted by the luminaire. These optical components may be designed to provide various beam angles, light distributions, or other characteristics depending on the specific application of the luminaire.

In operation, the luminaire receives power from an external power source, which is typically an AC or DC power supply. In some aspects, the power supply may be direct DC current from solar power, wind power, wave power, or other non-fossil fuel sources, as well as batteries, capacitors, or supercapacitors, or may be any form of AC current and any suitable voltage or amperage. The driver regulates the current and/or voltage supplied to the lights based on the input voltage and various control signals, such as those received from a dimmer switch or other control device.

In another aspect, a method is provided for replacing an existing electric light troffer with an LED luminaire, the light troffer being connected to a source of electricity and being held in place with a suspension mechanism such as suspension cables or a recessed ceiling mount, and the LED luminaire comprising: (1) a metallic frame, the frame comprising a recessed electrical receptacle and a connecting element for securing a component chassis, (2) a manually replaceable LED component chassis adapted for tool-free attachment to the frame, wherein an LED driver and at least one LED light panel is attached to the component chassis, and wherein the component chassis is adapted to connect with the connecting element of the frame without the use of tools, and wherein the component chassis comprises male electrical prongs adapted to connect with the recessed electrical receptacle of the frame, (3) a lens adapted to attach directly to the component chassis or frame without the use of tools, and optionally (4) at least one of the group comprising a network communication device and at least one sensor optionally adapted to cooperate with the network communication device, the method comprising:
(a) disconnecting the troffer from the source of electricity and removing the troffer from the suspension mechanism,
(b) attaching the frame to the suspension mechanism and connecting it to the source of electricity,
(c) plugging the electrical prongs of the component chassis into receptacle of the frame and further securing the component chassis onto the frame via interaction with the attachment mechanism of the frame, and
(d) attaching the lens to the frame or component chassis.

In another aspect, a method is provided for easily upgrading or repairing an existing LED luminaire installed in a frame. Upgrading may be done to provide added functionality such as adding or improving sensors, adding or improving network communication abilities such as Wi-Fi or Bluetooth systems, upgrading the LED driver, or adding enhanced LED light panels, etc. Repairing may be done to replace one or more defective or damaged LED lights or light panels, or a defective driver, sensor, or other components. The method may be carried out without the need for tools and without the need to disconnect or cut off power.

Thus, for an LED luminaire installed in a frame comprising a recessed electrical receptacle and a channel for receiving an LED driver attached to the back of an LED component chassis and comprising a connecting element for securing an LED component chassis to the frame (e.g., wherein the connecting element is adapted to connect with a cooperative element on the component chassis to secure the component chassis), the LED luminaire also comprising a lens attached to the frame or the component chassis, a method is provided for upgrading the LED luminaire comprising:
(a) removing the lens,
(b) manually detaching the component chassis from the attachment mechanism of the frame and withdrawing the prongs of the component chassis from the receptable of the frame to thereby separate the component chassis from the frame;
(c) attaching a new component chassis onto the frame, the new component chassis comprising a substrate, at least one LED panel attached to a front surface of the substrate, an LED driver attached to the rear surface of the substrate, and an electrical connector comprising male prongs, and a cooperative element that interacts with the connecting element of the frame to secure the component chassis to the frame, wherein the LED driver is adapted to fit within the channel of the frame; and
(d) re-installing the lens or installing a new lens if desired,
wherein the method can be carried out safely without the need to disconnect electrical power to the frame, without the need to use tools other than human hands (e.g., without the need to use a screwdriver, wrench, hammer, drill, pliers, wire cutter, etc.), and without the need to remove the frame.

This method may be used to upgrade a plurality of LED luminaires without the need to remove any of the frames or the need to turn off power to any of the LED luminaires and without the need for tools. In one aspect, a single worker may be able to ascend to a ceiling or other elevated region to gain access to the plurality of LED luminaires while carrying at least 10, 15, or 20 component chassis weighing no more than a total of 20, 30, or 40 kg, for example. Thus, the worker need not repeatedly descend and ascent to remove and receive the replacement parts, but may be able to upgrade or repair a large number of LED luminaires using equipment that can be physically carried onto a lift, mobile ladder, or other means for accessing the LED luminaires. Such efficiency can be especially important in upgrading a lighting system to provide smart features such as network for asset management, enhanced safety monitoring, improved energy usage, expanded use of sensors, and so forth.

In general, any limitation, element, feature, or step of any aspect or claim herein may be considered to be capable of being combined with any other limitation, element, feature, or step of any aspect or claim unless obviously impossible or deleterious, and such disclosure should be considered implicit if not already explicit.

### BRIEF DESCRIPTION OF THE FIGURES

FIG. 1 is a diagram showing the components of a smart lighting system

FIG. 2 depicts a building in which a smart lighting system is helping to direct evacuation in response to the use of a weapon in the building.

FIG. 3 depicts relationships between several components on a component chassis.

FIG. 4 depicts a component chassis according to one aspect of the disclosure herein.

FIG. 5 depicts a view of a frame with an LED component chassis attached.

FIG. 6 depicts a cross-section taken from FIG. 5.

FIG. 7 depicts a side view of the LED component chassis.

FIG. 8 depicts another luminaire having a variety of sensors.

FIGS. 9-11 depicts LED panels in which individual LED lights are in two color states to define a pattern useful in guiding evacuation in response to a dangerous incident.

FIG. 12 depicts a dual-band network also having indoor and outdoor networks.

FIG. 13 depicts a school safety system.

The figures should not be considered to be limiting, but as examples of various aspects intended to be used for explaining and understanding.

### DETAILED DESCRIPTION

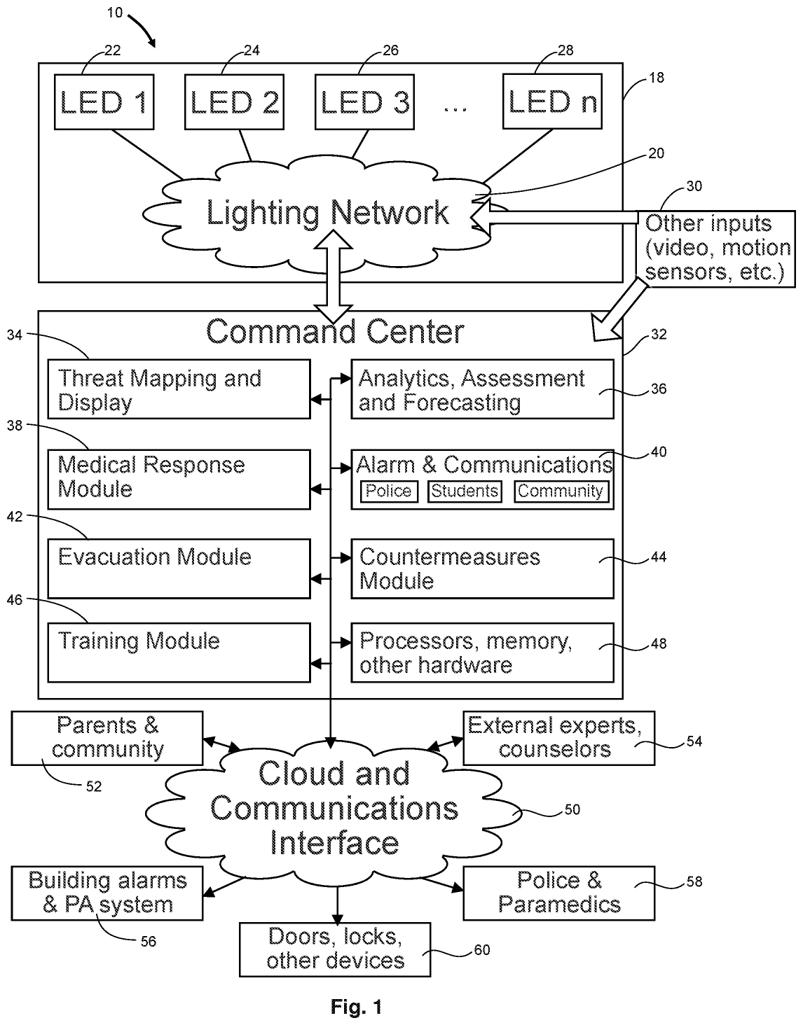

FIG. 1 depicts a smart lighting system 10 for enhanced safety comprising an array of LED lights 318 with a plurality of individual LED luminaires 22, 24, 26, 28 that cooperate to form a lighting network 20 that may be a mesh network supported by wireless communication devices (not shown), and may be operated according to any known protocol such as BACnet, a communication protocol for building automation and control (BAC) networks. The lighting network 20 communicates with a command center 32. Both the lighting network 20 and the command center 32 may also receive information from other inputs 30 such as video feed, motion sensor data, etc.

The command center 32 comprises a number of modules that may cooperate with one another, and may overlap in terms of the hardware and software programs employed. Thus a threat mapping and display module 34 may provide a user interface (not shown) that allows administrators and others, as desired, to see a map showing real time hot spots and, as desired, recent locations of past incidents and various ways of illustrating activity and pathways that persons of interest have taken and/or locations of staff or students that may be at risk. The interface may also display numerous forms of information such as number of shots fired at various zones, types of weapons that have been identified by the smart lighting system 10 or other means, classes of hazards that may be present (e.g., fire, chemical spills, an active shooter, rioters, etc.).

In some aspects, the threat mapping and display module 34 may map the location of each individual in a building. This, it may cooperate with RFID readers that read RFID tags (not shown) associated with individuals in the building, such as RFID tags embedded in school uniforms, in an id card, pendant, or other object, etc., or may relay on other identification tools such as facial recognition, gait recognition, voice recognition, etc. The mapping and tracking of individual locations as well as the locations of hazards may be used by other modules such as the evacuation module 42 discussed hereafter.

An analytics, assessment, and forecasting module 36 may process data to identify details about an incident in progress and may identify trends in the development of a hazard of concern to forecast possible next stage. The trends may include forecasting a path that a criminal may pursue in a building, forecast the spread of a fire or other hazards, forewarn of possible structural failures, etc. Artificial intelligence tools may be used in making such forecasts. The analytics may include results of facial recognition analytics based on camera or video data, gait analysis, voice recognition from microphone data, various biometric assessments, and sound analytics such as analysis of gunshots. Gunshot analytics may be performed on the edge of the network by microphones and processors on or associated with individual luminaires with access to, for example, a weaponry database that correlates various sound characteristics to specific weapons to identify the gun or type of bullets used in a shooting event, or to identify the nature of other incidents such as explosions, collisions, etc. Analysis may include calculation of reverberation decay, frequency analysis (e.g., Fast Fourier Transformation), wavelet analysis, etc., with various filters (high pass, low pass, etc.) and other tools to obtain signal characteristics that can identity details of an incident from sound pressure data and other acoustic, visual, vibrational, seismic, chemical, electromagnetic, or thermal data. Sound analytics for gunshot detection and gun or ammo identification may be carried out, for example, at frequency ranges such as from 1000 Hz to 8000 Hz, from 50 Hz to 3000 Hz, from 2000 Hz to 15,000 Hz, etc. The analysis may also be performed at the command center 32 or via resources accessible to the command center 32 via the cloud and communications interface 50.

A medical response module 38 may track the urgent medical needs of individuals due to acts of violence or other hazards, and communicate with paramedics or others via the cloud and communications interface 50 to ensure that the locations and needs of injured persons (not shown) are provided to first responders. The medical response module 38 may also identify when medical assistance or rescue operations can be safely carried out.

An alarm and communications module 40 can oversee, manage, or assist in managing both external and internal messaging to cope with an emergency or other incident. External messaging includes communications to external authorities such as the police or other first responders, including medical personnel, etc., as well as communication with the community, including news media or government officers. Internal communications with students, staff, customers, or others in the building or site may be also be managed, such as announcements over a public announcement (PA) system (e.g., via speakers mounted throughout the building), text messages to students, messages on electronic message boards or computer monitors, etc. Such messages may include instructions to stay in place, seek cover, escape through windows or doorways, or otherwise guide people in avoiding danger or seeking help.

In another aspect, the alarm and communications module 40 may communicate with external experts to gain guidance and other support. Communications may include live video feeds, data from sound analytics, etc.

The evacuation module 42 considers data on the nature of the incident and the location of hazards such as an active shooter in light of the distribution of people in a building and the layout of the building, and then determines optimum or satisfactory evacuation routes for those involved. Customized instructions to people in various locations may be provided via the alarm and communications module 40, and a record of such instructions provided may also be shared with first responders, the police, and other entities as needed. In addition, the evacuation module 42 may provide instructions to the lighting network 20 to direct individual LED lights 22, 24, 26, 28 to modify light output to give cues to people in or near the building about routes to avoid and preferred paths to take, or to direct them to seek over and stay in place.

The countermeasures module 44 directs, initiated, or recommends specific actions to take to mitigate a risk, such as stopping an active shooter from causing further harm or deterring or impeding an assailant. This can include providing directions to shut off lights near the shooter during a nighttime incident, to lock doors, to create distractions with light or noise, or to deploy technologies that may trap or incapacitate an assailant. The countermeasures module 44v may also assist in or conduct actions taken by various systems to manage a wide variety of threats or emergency situations, such as putting out a fire, dispersing a crowd, preventing a stampede, etc.

In one aspect, drones or robotics may be employed by the countermeasures module 44 to confuse or injure an assailant, employing such strategies as buzzing the target to use sound, motion, and light to frighten or distract, delivering an electric shock such as through the use of Taser-like device or other means, delivering smoke or dust to obscure vision, delivery of gas or noxious agents to such as pepper spray or other irritants to temporarily blind, stun, render unconscious, directing laser light to the face of an assailant, releasing a stun or flash device, etc. The drones may interact with the lighting network 20 to know the location of the target in real time to ensure that the target is reached and properly treated.

A training module 46 may be provided that periodically encourages training of building occupants so that they are familiar with the signals (e.g., changes in light color, intensity, or apparent motion of light or creation of patterns by the light, as well as audible signals, text messages, etc.) so that occupants can respond quickly and appropriately as directed by the command center 32 or in response to lighting signals generated by edge components in the lighting network 20. The training module 46 may assist in scheduling of training, and may keep a database of occupants and their training status Training may comprise both video training, live exercises such as mock rehearsals, written materials online or physically printed, quizzes, etc.

Other modules or components may also be present, including processors, memory, and other hardware 48. Memory may include any known means of storing information, including cloud storage or local storage on various media such as non-transitory computer readable media, on which the stored information may include data such as a database, commands or instructions such as a computer program or app, graphics and instructions for a graphical user interface that may be used for managing the smart lighting system 10, etc. Other modules or functions may also be considered that are not shown.

The cloud and communications interface 50 assist in connecting the smart lighting system 10 to other entities or systems. This may include communications to parents and community 52 (especially when a school or related organization is involved), external experts and counselors 54, the building alarms and PA system 56, police and paramedics 58 or other first responders or emergency response personnel, and doors, locks, and other devices 60, which may be operated from a distance to help reduce risks.

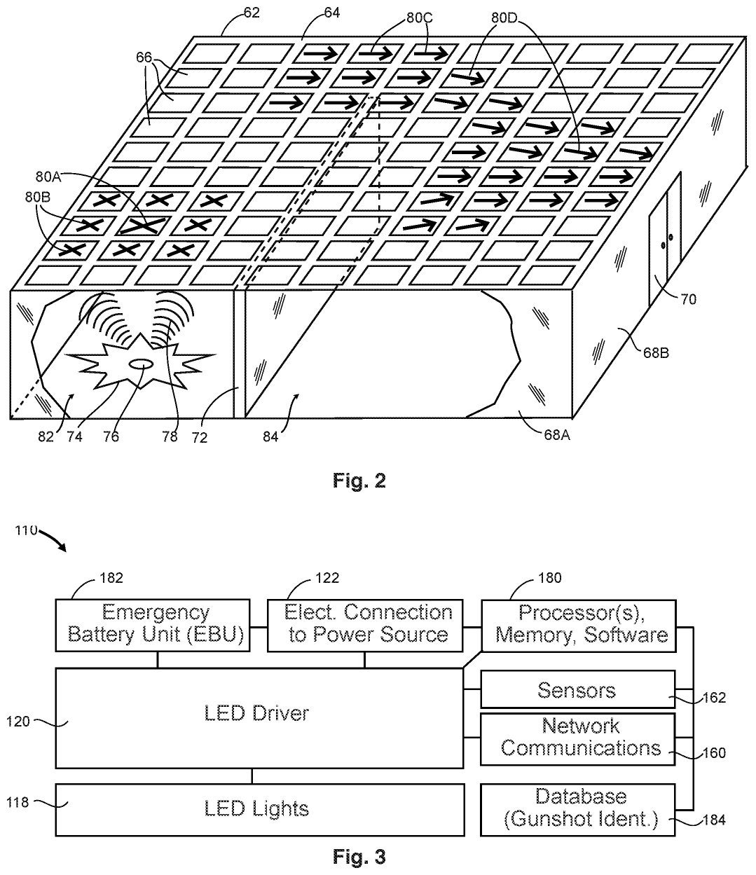

FIG. 2 depicts a building 62 with a ceiling 64 beneath a roof (removed for clarity) having a plurality of luminaires 66 installed in an array. The building has exterior walls such as the front wall 68A and side wall 68B that are shown, with front wall 68A largely cut away to reveal interior structures such as the wall 72 between a first room 82 and a second room 84. Also depicted is a ballistic event 74 depicted with a star shape, the ballistic event 74 having a location 76 where a gunshot occurred. The location 76 can be determined by triangulation based on microphone data of sound pressure versus time from acoustic waves 78 measured by luminaires 66 in the region of the ballistic event. In response to determining the location 76 of the ballistic event 74, the closest luminaire 80A may immediately change the light it provides in order to characterize danger. The closest luminaire thus may display a large “X”, change to a color such as red, flash it's LED lights (individual diodes) in a particular pattern, emit a sound, etc. The adjacent luminaires 80B may show a similar display (e.g., a smaller “X” or a similar but optionally less intense or less extreme color change or a similar flashing pattern, etc.).

The luminaires 66 form a network (not shown) that can communicate its data with a command center (not shown) that may provide instructions regarding evacuation routes and countermeasures. In FIG. 2, the command center's analysis of the distribution of occupants in the building and of the location of hazards has proposed an escape route for the majority of occupants that is indicated by a combination of a first set of luminaires 80C displaying arrows or other indications of direction for moving from the first room 82 to the second room 84, and a second set of luminaire 80D providing indications of direction for moving from the second room 84 to the exterior of the building via a door 70.

FIG. 3 depicts the relationship between various elements that may be considered for the component chassis 110 of the LED light of a luminaire 66 (not shown) in some aspects. The component chassis 110 comprises LED lights 118 that may be mounted on a substrate (not shown) such as a printed circuit board, which is connected to an LED driver 120 which receives power from an electrical connection 122 providing AC or DC current (this may also comprise a power over ethernet system) or from an emergency battery unit (EBU) 182 that may be used when there is a power outage, for example. Processors, memory, and software 180 may be provided on the component chassis 110, with programming and other information that may be periodically updated via the cloud or other sources (not shown) through a network communication device 160. The LED driver 110 can communicate with the processors, memory, and software 180, with the network communications device 160, and also with one or more sensors 162 such as a microphone, camera, etc., that may be connected directly on the component chassis 110, whether mounted on the component chassis 110 itself or adjacent to it, or mounted remotely with communication occurring by wireless means with the component chassis 110. A database 184 may also be installed on the component chassis 110 such as a database of gunshot sound characteristics to allow rapid identification of the like gun type and ammunition type if a detected gunshot event. Rapid detection of the gunshot and gunshot type executed rapidly on one or more luminaires 66 may result in rapid information creation for the most effective management of the incident.

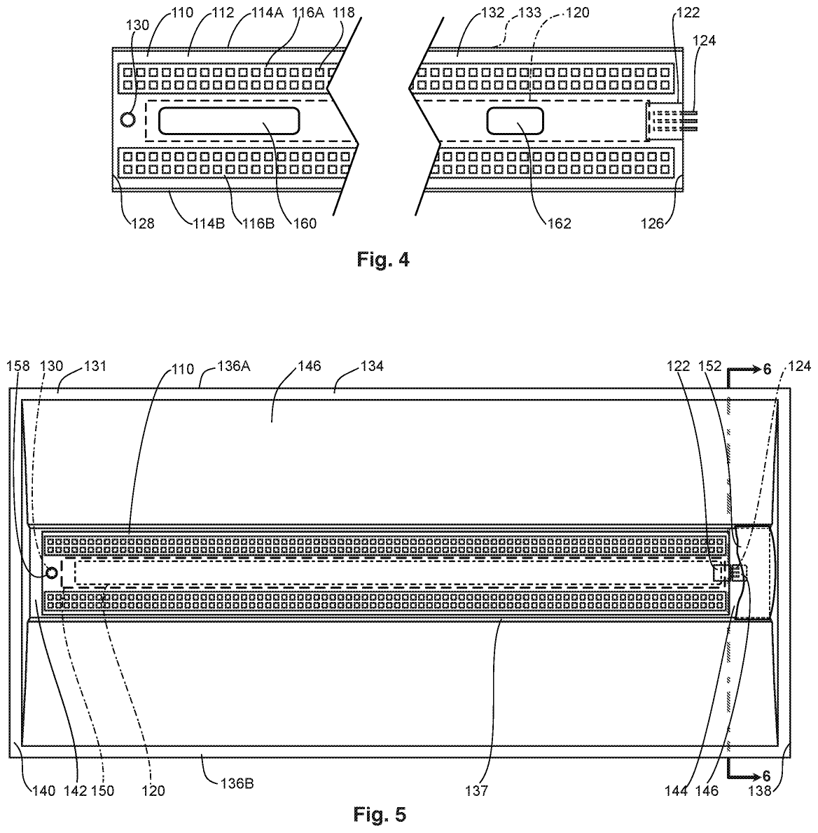

FIG. 4 provides further details for a component chassis 110, here shown comprising a substrate 112, a first side 114A (which can also be termed a “longitudinal edge”), an opposing second side 114B, a first LED panel 116A (which can also be termed an “LED strip” in this case) which, in the aspect shown, comprises a plurality of individual LED lights 118, each an LED chip or diode. A second LED panel 116B is also shown, though there may any number of LED panels, including only one if desired. The component chassis 110 also has a first end 126 and an opposing second end 128. The LED panels 116A, 116B are mounted on the front side 132 of the substrate 112. Out of view is the back side 133 of the substrate, on which is mounted the LED driver 120.

An electrical connector 122 comprises male prongs 124 at or near or protruding from the first end 126 of the component chassis 110. The connector 122 may employ any suitable NEMA connector system, for example, and may be adapted for AC, DC, or both. The electrical connector 122 is in electrical communication with the LED driver 120 and the electrical connector 122 or the LED driver 120 may be in communication with other electrical components described herein. The prongs 124 depicted in the figures are shown without a surrounding housing (typically plastic) for simplicity and clarity. Such housing may be in place for safety and stability, as desired, and the depiction of the prongs or male connectors without such is not intended to suggest that housing must not be used for the prongs.

The substrate 112 also is connected to or comprises a cooperative element 130 (here shown as an aperture) that may be used to attach the component chassis 110 to a frame (not shown) or other mounting surface through interaction with a connecting element (not shown). Such a connecting element may have a projecting attachment (not shown) that can snap into the cooperative element 130 to secure the component chassis 110.

The substrate 112 may also be attached to a network communication device 160, which may comprise an antenna and circuitry for network communication via any suitable protocol such as Zigbee, Bluetooth, Wi-Fi, 5G, 6G, UHF, etc., at any useful frequency (e.g. from 100 MHz to 12 GHz, such as from 2 to 3 GHz, from 5 to 10 GHz, 6 to 12 GHz, etc.), and may be adapted, for example, to include IEEE 802.15.4-compatible 2.4 GHz band wireless connection capabilities, 5 GHz capabilities, etc.

One or more sensors 162 may also be mounted on the substrate 112 or otherwise associated with the component chassis 110 or the frame (not shown), and here is shown mounted on the front surface 132 of the substrate 112. The one or more sensors may be integrated into a single sensor device or may be disposed at various locations on the substrate 112 or the frame (not shown).

FIG. 5 depicts an LED luminaire 131 comprising a frame 134 having a first longitudinal edge 136A and an opposing second longitudinal edge 136B and a first end 138 and an opposing second end 140. The viewpoint provided corresponds to what a viewer would see looking up at the LED luminaire 131 as installed in a ceiling (not shown) or as suspended from above. Such a ceiling may be a drop ceiling, which may include or be known as a drop ceiling, a T-bar ceiling, etc. Alternatively, it may be a non-drop ceiling, which also may be known as or include a permanent ceiling, hard ceiling, solid ceiling, fixed ceiling, concrete ceiling, plastered ceiling, traditional ceiling, permanently attached ceiling, solid ceiling, rigid ceiling, or structured ceiling.

An LED component chassis 110 is installed in the center of the frame 134, with reflector panels 146 at either longitudinal side. An easy-connect lens 152 is shown only in part to make the component chassis 110 more visible, but may be a translucent plastic material that can be attached to the walls of a central recession 137 in the frame 134 that receives the LED component chassis, or can attach to a ridge or other connecting structures (not shown) that may be present on the LED component chassis 110. Within the central recession 137 is a narrower central channel 150 that is adapted to receive the LED driver 120 or other electronics of the LED component chassis 110.

An electrical receptacle 147 is mounted on a surface 144 adjacent the LED component chassis 110, and can receive the prongs 124 from the LED component chassis 110.

Here the cooperative element 130 in the LED component chassis 110 is adapted to receive a flexible connecting element 158 attached to the frame 134 that can pass through the cooperative element 130 to establish a firm connection and secure the LED component chassis 110, in cooperation with the connection established by the electrical connection 122 and the receptable 147, and other optional connecting elements (not shown). Numerous other connection systems could be used instead of or in addition to that which is shown.

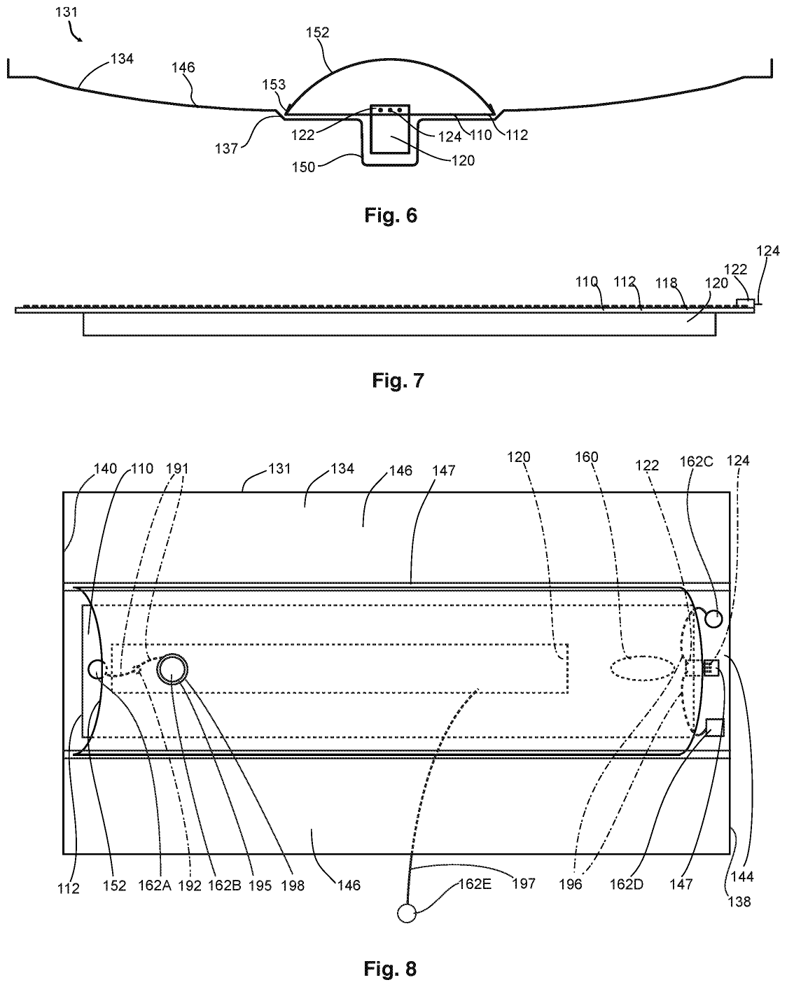

FIG. 6 shows a cross-sectional view of the LED luminaire 131 taken from FIG. 2. The LED component chassis 110 as depicted comprises clips 153 that retain the lens 152. Also shown is the electrical connector 122 and the prongs 124 on the front surface of the LED component chassis 110, with the LED driver 120 mounted below the substrate 112 of the LED component chassis 110. The LED driver 120 fits within a channel 150 in the frame 134.

FIG. 7 depicts a side view of the LED component chassis 110 showing the substrate 112, the LED lights 118, the LED driver 120, the electrical connection 122 and the associated male prongs 124.

FIG. 8 shows another aspect of an LED luminaire 131 with multiple sensors 162A-162E with various locations relative to the lens 152. A frame 134 with reflector panels 146 holds a component chassis 110 in the center of the LED luminaire 131 having LED lights (not shown) and an LED driver 120, with the lens 152 held in place on the frame 134 by interaction with connecting slots 147 therein (e.g., it may be a flexible panel that can snap into the recessed slots 147 and thereby be retained in place). Sensor 162A, which may be a microphone, for example, is mounted on the substrate 112 of the component chassis 110 and is at least partly beneath the lens 152, while sensor 162B, which may be a camera or motion detector, is exposed through a hole 198 of the lens 152 and thus may have its line of sight to the region below the light not impeded or obstructed by the lens 152. A resilient ring 195 mounted around the hole 198 may allow the sensor 162B to snap in and out of place with respect to the lens 152 to simplify the process of removing is installing the lens 152. Cables 191 connects sensors 162A, 162B to the LED driver 120 via an opening 192 in the substrate 112.

Near the first end 138 of the LED luminaire 131, a surface 144 supports the receptable 147 and may also support sensors 162C, 162D, each of which may be electrically connected via cables 196 to the electrical connector 122 of the component chassis 110, which in turn is connected to the LED chassis 120. Sensors 162C, 162D may be microphones, smoke or fire detectors, accelerometers, air quality monitors, RFID readers adapted to obtain information from active or passive RFID tags, and the like.

Also shown is a communication device 160, which may be mounted on the component chassis 110 or elsewhere on or near the frame, electrically connected to the LED driver 120, which may comprise one or more processors for guiding the collection or processing of data from the sensors 162A-162E and sharing data or the results of computations or other analysis with a command center (not shown) and/or with a network (not shown).

Sensor 162E is not mounted on the component chassis 110 nor on the frame 134 of the LED luminaire 131, but may be mounted remote from the LED luminaire 131 such as on an adjacent ceiling tile (not shown) or other structure, with a cable 197 connecting the sensor 162E electrically with the LED driver 120 or associated processors (not shown). In this case, the sensor 162E may not be readily visible, but may be hidden on top of ceiling tile or within other material (not shown), and the cable 197 likewise may not be readily visible, but may originate from behind (on top of, out of sight) the LED luminaire 131 and pass largely undetected to an adjacent region. Such a sensor 162E may be camera, microphone, etc.

Likewise, if desired, the communication device 160 may also be installed remote from the LED luminaire 131, connected via a cable or wire, not shown. (In general, it should be understood that the term “cable” may include “wire” and vice versa, unless otherwise indicated.)

As shown, the prongs 124 of the electrical connection 122 establish electrical contact with the receptacle 147 of the frame 134.

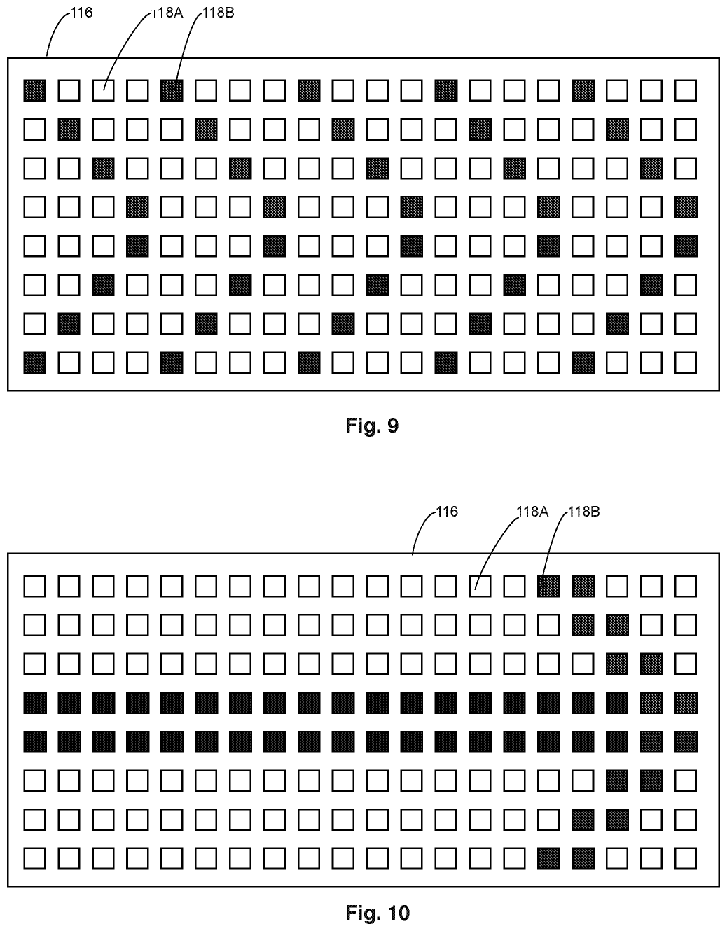

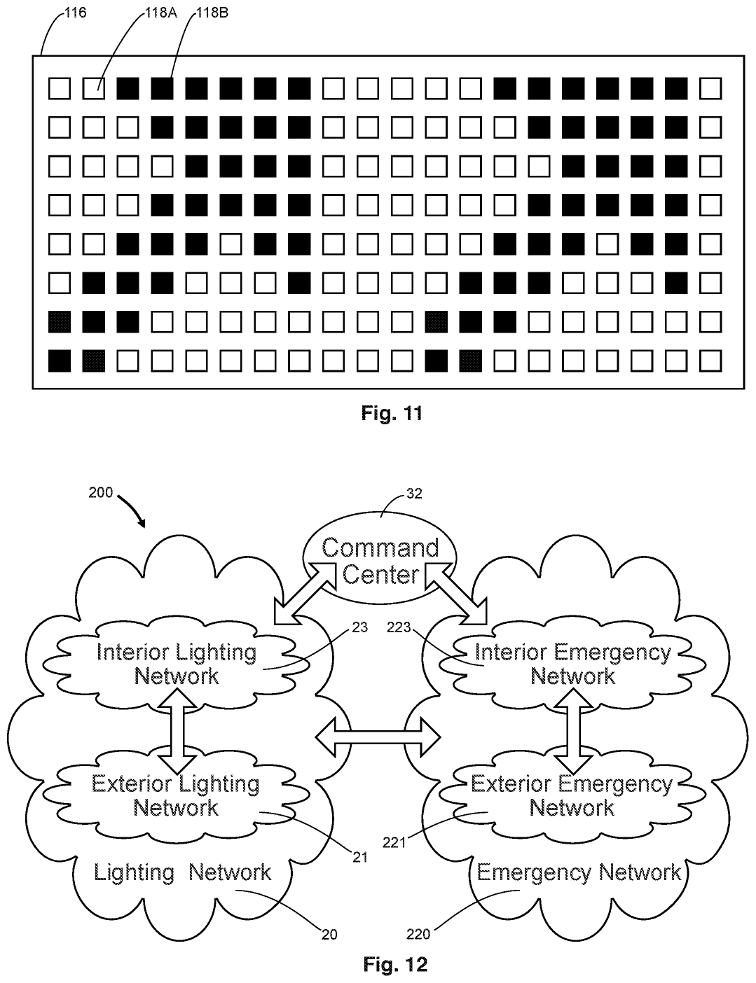

FIGS. 9-11 each depicts an LED panel 116 in which a first set of LED lights 118A is in a first color state, and a second set of LED lights 118B is in a different color state, where the two color states collectively form patterns that are be recognized by the occupants of a building during or after a dangerous incident as providing directions for evacuation or giving other guidance such as commands to “shelter” or “stay in place” to help mitigate the risks or hazards faced. These patterns, for examples, may represent arrows showing a direction to follow to seek safety.

FIG. 12 depicts a dual-band network 200 comprising a lighting network 20 and an emergency network 220. The lighting network 20 comprises an interior lighting network 23 which may be a mesh network formed from smart luminaires (not shown) as well as other communicating devices in a building, such as video cameras and other sensors, and may also comprise an exterior lighting network 21 comprising external lights, including smart LED luminaires or other smart lights in the form of street lights, external building lights, etc., that may also comprise, be physically attached to or connected with, or be near (e.g., within 2 meters or 1 meter) other sensors.

An emergency network 220 is also provided, which may operate on a different band than the lighting network 20 or operate on a different protocol. A different band may be a fine subset of a broad band, such as narrow frequency bands around 2.4 GHz, or may differ at a larger scale such as 5 GHz vs. 2.4 GHz. Alternatively, the exterior lighting network 21 may operate on a different protocol or band than the interior lighting network 23, and the exterior emergency network 221 may operate on a different protocol or band than the exterior lighting network 223, such as Zigbee in one case and BlueTooth in the other, or all networks may operate on BlueTooth, etc., as desired. In some aspects, an emergency detected in the exterior emergency network 221 may be communicated with the command center 32 or directly with the interior emergency network 223 to help security personnel and the occupants of the building (not shown) to protect the building and its occupants from a hazard such as an active shooter. Detection of a gunshot outdoors, by way of example, may then give the staff of a building (not shown) to take immediate actions to secure the building and protect its occupants.

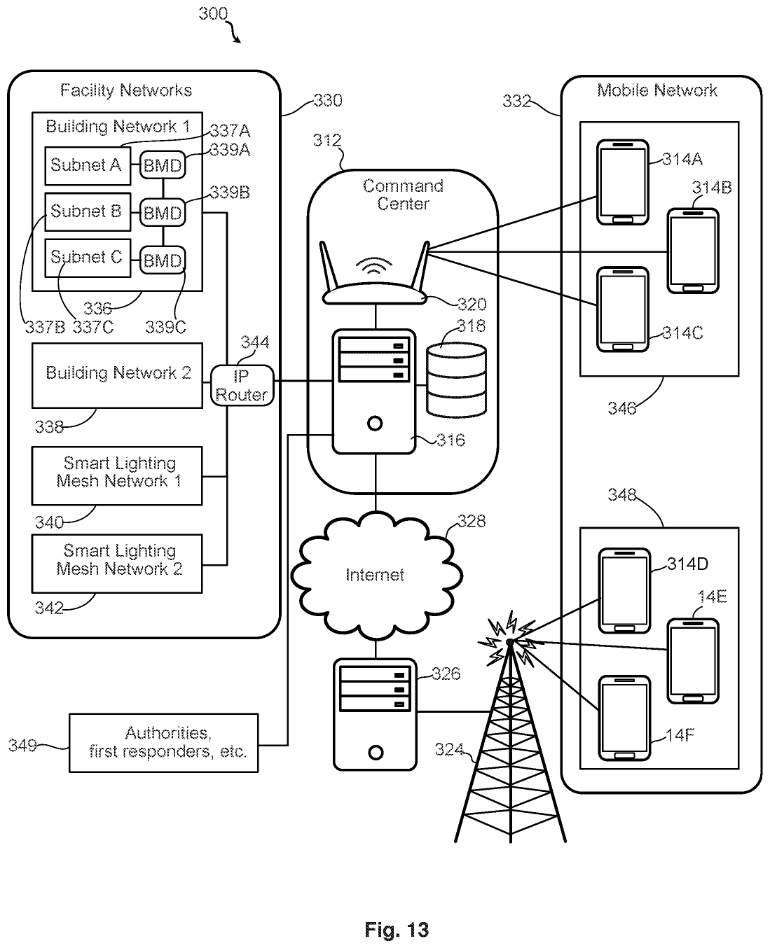

FIG. 13 depicts a safety system 300 having a command center 312 with a command center server 316 and an associated database 318. The command center 322 uses a wireless router 320 to communicate wirelessly with the Wi-Fi subnet 346 of a mobile network 332, in which one or more mobile devices 314A, 314B, 314C (depicted here as cell phones) can receive and share information via the wireless router 320. The command center server 316 also communicates with the cellular subnet 348 of the mobile network 332, which may have one or more mobile devices 314D, 314E, 314F (depicted here as cell phones) that can share and receive information via a cellular tower 324, which in turn may communicate with a cellular server 326 that is connected to the Internet 328. The command center server 316 has access to the Internet 328 and thus can receive and share information with the cellular server 326, which can then convey information to the cellular subnet 348.

The information shared by the devices of the mobile network 332 may comprise acoustic signals obtained by the devices. For example, in response to a loud sound that could be a gunshot (not shown), nearby devices may be instructed to share the last few seconds of sound as it is continually cached. This allows augmented recordings from just before the loud event of concern, providing further context and data that may help resolve the nature of the sound. Phones in areas of importance may also be solicited for visual data from a camera, for example, as well as light meter data, accelerometer data, and other useful sensor data. Phones in critical areas may continue to be monitored until the danger at hand is averted, stabilized, or determined not to be a danger requiring immediate action.

The command center 312 also communicates with the facility networks 330 via at least one IP router 344. The facility networks 330 comprise at least one network associated with a protected region (not shown), depicted here, by way of example, as a first building network 336, a second building network 338, a first smart lighting network 340, and a second smart lighting network 342. Details within the first building network 336 are shown, and such details, though not shown for the other units of the facilities network 330, may be understood to have similar components or any other suitable components for such networks or subnets. Thus, the first building network 336, which may be a BACnet or other fixed network for a first building or a first region of a building (not shown), may comprise subnets shown as subnet A 337A, subnet B 337B, and subnet C 337C, each of which may cover or pertain to a particular portion of a building or floor, or may cover a particular type of equipment or facility such as windows, doors and any entrances or exits, elevators, manufacturing equipment, plumbing, HVAC, and security devices (e.g., cameras, microphones, security doors, etc.) in the building or its exterior, including a parking lot. Each subnet 337A, 337B, 337C may also be provided with a broadcast management device (BMD) 339A, 339B, 339C, respectively, that can be used to allow devices within a subnet 337A, 337B, 337C to communicate outside of the subnet with other subnets within the first building network 336 or with the IP router 344, if needed.

The second building network 338 may be associated with a second building or another floor in a building of interest, or could also be associated with an exterior region such as a parking lot, an adjacent part or field, a helicopter landing pad on a roof or other structure, and so forth. It may have a BACnet or other suitable network of predominantly fixed devices.

The first smart lighting mesh network 340 and the second smart lighting mesh network 342 may each comprise a plurality of smart LED luminaires (not shown) such as luminaires comprising a component chassis (not shown) with a modular LED driver coupled with one or more radios (not shown) making it adapted for forming a mesh network. The smart luminaires may further comprise or be associated with various sensors such as microphones, accelerometers, cameras, motion detectors, gunshot sensors, etc., which can assist in detecting danger. The first and second lighting mesh networks 340, 342 may be in different buildings, different floors, or different portions of the same floor in a building (not shown), or could cover adjacent or interspersed areas, in which case they may operate on different bands or otherwise be segregated in terms of network operations, if desired. Both may communicate via one or more IP routers 344, such as a BACnet/IP router or multifunctional, multiband router.

It should be noted that the networks of the facility networks 330 could be a single network or any number of networks, and each one may independently be a mesh network, a distributed network, a BACnet, etc.

Turning again to the command center 312, as the command center server 316 analyzes data from the various sensors of the mobile network 332 and the facility networks 330, when characteristics of a gunshot or other hazard are identified and confirmed as likely to represent a genuine danger, the command center 312 can issue alerts, warnings, and other information to proper authorities and first responders 349, while also providing alerts and guidance to people within or near the protected region or near the region of danger. Such guidance may include instructions on how to seek cover or flee the area safely, as well as guidance to first responders and others on potential medical needs of anyone injured. Countermeasures (not shown) may also be directed from the command center 312, either automatically with AI-assisted instructions or pre-programmed directions corresponding to the situation detected, or with human approval or directions from authorized personnel to modify or veto automatically proposed countermeasures. One or both of the smart lighting mesh networks 340, 342 may be used in the countermeasures as well as in the guidance to people in the areas, such as using lights to signal danger, indicate escape routes, or show the location of the assailant to assist police. The fixed network formed by smart LED luminaires has the advantage of continuing to monitor the facility and a suspected assailant even after people and their mobile devices have largely fled the area. This network can be useful in directing countermeasures against an assailant or other hazard, especially if the smart LED luminaires are equipped with microphones, cameras, or other suitable devices. Such countermeasures may include directing drones to harass or deter an assailant, strobe effects or darkening of rooms to distract or impede the assailant, commands to a BACnet to lock doors or take other actions to impede or deter the assailant's movements, etc.

The command center server 316 can access one or more databases 318 for various purposes, such as comparing measured acoustic properties of a suspected gunshot to determine the type of weapon and ammunition used, and comparing reverberation data and other acoustic information to prior trials conducted in the facility of interest to interpret the acoustic data, which may assist in better understanding the location of the incident and the nature of the shots fired. The databases 318 need not all be physically near the command center server 316 but may be in the cloud or other remote locations.

Thus, in a first aspect, a smart LED lighting system is described, having:
(1) an array of LED luminaires, each LED luminaire comprising a component chassis having an LED light panel and a driver for controlling light output from the LED light panel, the component chassis also being connected to a microphone, and also connected to a communication device for sending and receiving information, the array of LED luminaires forming a smart lighting network; and
(2) a command center adapted to communicate with the smart lighting network, the command center comprising an analytics module for assessing the danger to occupants throughout a building in response to detection of a dangerous incident, and an evacuation module for guiding occupants to pursue a safe route; wherein in response to detection of a dangerous incident based on information provided by the smart lighting network, the command center directs the smart lighting network to modify its light output to assist in evacuating occupants.

In a second aspect, the smart LED lighting system of aspect 1 is described, further adapted or configured to modify the light output of one or more luminaires in response to detection of a dangerous incident to display a lighting pattern indicating a direction of travel to pursue.

In a third aspect, the smart LED lighting system of aspect 2 is described, adapted or configured to also modify the color of the light output of one or more luminaires in response to detection of a dangerous incident to display an indication of danger.

In a fourth aspect, the smart LED lighting system of any of aspects 1 to 3 is described, wherein one or more luminaires comprises a microprocessor configured to analyze a sound signal captured by the microphone and determine if the sound is indicative of a gunshot.

In a fifth aspect, the smart LED lighting system of aspect 4 is described, further having access to a database of gunshot characteristics for specific types of guns or ammunition, wherein the microprocessor is adapted to compare a gunshot sound to the database to determine what type of gun or ammunition has been discharged.

In a sixth aspect, the smart LED lighting system of any of aspects 1 to 5 is described, wherein the command center has access to a database of gunshot characteristics for specific types of guns or ammunition, and has a processor adapted to compare a gunshot sound to the database to determine what type of gun or ammunition has been discharged.

In a seventh aspect, the smart LED lighting system of any of aspects 1 to 6 is described, wherein the command center further comprises a training module for training occupants of the building in how to escape safely in response to a hazard guided by the modified light output of the LED luminaires.

In an eighth aspect, the smart LED lighting system of any of aspects 1 to 7 is described, wherein one or more of the LED luminaires comprises a component chassis having a processor and memory having a database of gunshot related data, wherein the processor is adapted to analyze the characteristics of a gunshot sound and to identify the weapon or the ammunition used, based on comparison of the characteristics of the gunshot sound with the database of gunshot related data.

In a ninth aspect, the smart LED lighting system of any of aspects 1 to 8 is described, adapted to cooperate with an exterior gunshot detection system, whereby the exterior gunshot detection system is adapted to alert the command center of the nearby danger.

In a tenth aspect, the smart LED lighting system of any of aspects 1 to 9 is described, comprising a dual band network, with one band adapted for control and monitoring of a lighting network and one band adapted for emergency response.

In an eleventh aspect, a method is described for evacuating the inhabitants of a building in response to a sound indicative of a dangerous incident, the method comprising the steps of:
a) providing a building with a smart lighting network comprising an array of LED luminaires each comprising a power source, an LED driver connected to the power source, a microphone electrically connected to the LED driver, a processor and an associated memory in communication with the microphone, an LED panel operatively associated with the LED driver an adapted to provide a variety of light outputs as directed by the LED driver, a communication device in communication with the processor, wherein the LED luminaires of the array communicate to form a network; and
b) monitoring ambient sound via the microphones of the smart lighting network for a sound with a sound pressure above a predetermined threshold, and when the threshold is exceeded, analyzing the sound using at least one of the processors of the smart lighting network according to instructions recorded in the associated memory to determine if the characteristics of the sound are likely those of a gunshot, and in response to detection of a likely gunshot, modifying the light output at least one of the luminaires to indicate a state of danger and modifying the light output of plurality of luminaires to indicate an evacuation route.

In a twelfth aspect, the method of aspect 11 is described, wherein the step of modifying the light output is carried out in response to directions issued by the processor.

In a thirteenth aspect, the method of aspect 11 is described, further comprising communication the detection of the gunshot with the command center of any of aspects 1 to 10.

In a fourteenth aspect, the method of aspect 13 is described, wherein the step of modifying the light output is carried out in response to directions issued by the command center.

In a fifteenth aspect, the method of aspect 13 is described, wherein the command center has access to a database of gunshot characteristics for specific types of guns or ammunition, and has a processor adapted to compare a gunshot sound provided by the smart lighting network to the database to determine what type of gun or ammunition has been discharged.

In a sixteenth aspect, the method of aspect 13 is described, wherein the command center further comprises a training module for training occupants of the building in how to escape safely in response to a hazard guided by the modified light output of the LED luminaires.

In a seventeenth aspect, the method of aspect 13 is described, wherein the command center comprises a countermeasures module capable of directing actions against an assailant selected from the group comprising increasing or decreasing light intensity provide by the smart lighting network, automatically locking doors, activating one or more drones to approach the assailant, and delivering a chemical or other material to impede the assailant.

In an eighteenth aspect, the method of any of aspects 11 through 17 is described, wherein the smart lightning network may be that described in any of aspects 1 through 10, wherein the smart lighting system further comprises one or more sensors selected from the group consisting of cameras, motion detectors, IR sensors, accelerometers, and flash detectors.

In a nineteenth aspect, the method of any of aspect 11 through 18 is also described, wherein the array of LED luminaires comprises a plurality of microphones, each associated with a respective LED luminaire the microphone having an AOP of at least 130 dB and a diameter of less than 20 mm.

In a twentieth aspect, the method of any of aspects 11 through 19 is also described, wherein the array of LED luminaires comprises an LED luminaire electrically connected to at least one of the group consisting of a motion detector and a camera.

Unless contradictory or physically impossible, any aspect described herein may be combined with any other aspect. For example, any connectors, sensors, LED drivers, frame size and format, light type, and so forth may be freely combined even if such combinations are not expressly set forth herein. With respect to multiple ranges being listed for some feature or characteristic, the ranges each having an upper and lower limit, the lower limit of any such range may be used with the upper limit of any range. Thus, for example, in saying that the luminaires described herein may have a width ranging from 1 to 6 feet or from 2 to 5 feet, it is understood that ranges of 1 to 5 feet and 2 to 6 feet are also disclosed and may be claimed.

### Further Technical Considerations

Control systems use in association with the LED luminaires described herein may be responsive to conditions of ambient light. As used herein, “ambient light” refers to visible radiation (light whose wavelength is between about 450 nm and about 700 nm) that pervades an environment or space. It is the indirect light that fills a local environment and is perceptible to people in the environment. Likewise, “ambient light level” refers to the illuminance, or luminous flux on a surface per unit area. The illuminance is a measure of how much the incident light illuminates the surface and may be measured in lux (lumens per square meter) or foot-candles.

Control systems can include controls for the brightness of individual LED lights. Brightness can be controlled with variable voltage, such as the use of a voltage adjusting block (VAB) as described in U.S. Pat. No. 10,743,385, “Adjustable voltage constant current light emitting diode (LED) driver for automotive headlights,” or with Pulse Width Modulation (PWM) or other known methods. PWM dimming, for example, changes the light output by varying the duty cycle of a constant current in the string of lights to change the average current, in effect, and thus affect the brightness of the perceived light. Examples of commercial LED control systems include the products of Avi-on Products (Park City, UT). Such controls may be operated by BlueTooth or other wireless methods to control the LED driver and other aspects of the LED luminaire according to manual input, programmed settings, etc., in response to changing needs or environment factor or data from various sensors. Control systems may be part of a network, etc.

An LED light may operate with a forward voltage within any practical range, such as in the range of 3.0 to 3.5V, and may operate with forward current of any suitable value such as at about 350 mA, 700 mA, or 1050 mA, and may have a corresponding power rating of, say, 1, 2, or 3 Watts.

LED drivers may be constant current drivers, constant voltage drivers, or hybrid drivers, for example. LED drivers may include any driver that can be attached to a component chassis as described herein. For example, commercial LED drivers may include those marketed by such companies as Signify (Eindhoven, Netherlands), formerly known as Philips Lighting, Mean Well (New Taipei City, Taiwan), Tridonic (Dornbirn, Austria), OSRAM (Munich, Germany), Lutron Electronics (Coopersburg, PA), Acuity Brands (Atlanta, GA), Inventronics (Hangzhou, China). LED drivers may employ pulse width modulation (PWM) as a control strategy to control an array of LED cells, or may employ analog dimming, digital dimming, or other methods.

Lighting systems described herein may employ AC or DC current at any useful voltage range operate at any suitable power level or wattage. Thus, the lighting systems described herein may be compatible with either or both alternating current (AC) and direct current (DC) power sources. The system may be configured to operate with common voltage levels, including but not limited to 120V, 240V, and 277V AC, or DC voltages in a range of 12V to 48V or 12V to 96V or 2V to 24 V. Additionally, the system may operate at standard wattage levels commonly used for LED lighting, ranging, for example from 5 W to 100 W or from 10 W to 150 W per luminaire or unit. The system may also be adapted to accommodate three-phase voltage systems, typically ranging from 208V to 480V AC, for higher power applications or for integration into larger electrical infrastructures.

The luminaire may include integrated components such as transformers, rectifiers, or voltage regulators to convert incoming electrical power to the appropriate levels needed for both the LED lighting system and any attached or cooperating sensors. For example, the luminaire can be connected to a standard 120V AC line, or it may be configured to receive multiple incoming voltages to accommodate regional power standards (e.g., 240V in Europe, 120V in the US, etc.). The internal transformer or rectifier can then convert the incoming AC power to lower DC voltages, such as 12V DC or 24V DC, which are commonly used for sensors like cameras, microphones, or motion detectors. The modular LED driver or component chassis within the luminaire can be designed to supply these various power outputs, enabling integration of both the lighting system and sensor components with a single power source.

### Further Software Considerations

A variety of algorithms can be employed to achieve various objectives of the smart lighting system and command center. For example, known algorithms for triangulating the location of an event based on microphone input can be applied to detect and track a particular danger. An example of one approach for gunshot detection and tracking is outlined here, though it can be adapted for many other incidents and dangers. This may be, for example, part of the software executed by the command center 32 in FIG. 1, with respect to the analytics, assessment and forecasting module 36 and/or the threat mapping and display module 34. Here is the outline of a Gunshot Detection and Triangulation Algorithm:

### Gunshot Detection and Triangulation Outline, Step 1: Preprocessing of Audio Signals

Receive Signals: Each microphone on the LED luminaires captures sound signals in real-time and transmits them wirelessly to the central processor. The transmitted signal may include timestamp information as well to ensure that the time of key events are recorded. Each signal is associated with a specific sensor having a known location.
Signal Synchronization: Use timestamp data sent by the microphones or other timing data to align the signals for timing analysis.
Noise Filtering: Apply an optional noise-reduction filter to isolate relevant gunshot sound waves, filtering out background noise.

### Step 2: Identify Gunshot Characteristics

Sound Intensity: Measure the amplitude of the sound signal to assess sound intensity. Gunshots typically produce a peak in intensity.
Time of Arrival (TOA): Measure the time when the sound is first detected by each microphone.
Sound Characteristics: Analyze echoes, peaks, and frequency characteristics (such as muzzle blast vs. echo, shock wave identification, etc.) to distinguish between the gunshot and its reflections.
Optionally apply artificial intelligence or a neural network (e.g., the convolutional neural network described by Simone Raponi, Gabriele Oligeri, Isra M. Ali in “Sound of Guns: Digital Forensics of Gun Audio Samples meets Artificial Intelligence,” arXiv: 2004.07948v2 [eess.AS], Mar. 1, 2021, https://doi.org/10.48550/arXiv. 2004.07948, to further characterize the gunshot data. (This may be done as part of Step 5 if desired.)

### Step 3: Determine Time Differences (TDOA)

Compute Time Differences: Calculate the time difference of arrival (TDOA) between the signals from various microphones. Based on the known location of the microphones, the differences in arrival times provide a basis for triangulation.

### Step 4: Triangulation of Shooter's Location

Distance Calculation: Use the speed of sound and the TDOA to calculate the distance between each microphone and the source of the event (i.e., the location of a shooter).
Geometric Triangulation: Using the calculated distances, perform triangulation to estimate the shooter's location.
With at least three microphones, apply pseudo-range multilateration (also known as hyperbolic positioning) or related methods to determine the likely location of the shooter for each apparent gunshot incident.
Use methods such as non-linear least squares optimization to handle errors and provide a more accurate location.
Check conflicts in the data that may indicate the presence of two different events occurring at approximately the same time. Determine if there is more than one shooter, more than one gun being fired.

### Step 5: Post-Processing

Check conflicts in the data that may indicate the presence of two different events occurring at approximately the same time. Determine if there is more than one shooter, more than one gun being fired.
Verify Sound Characteristics: Further analyze sound characteristics like echoes and peaks to confirm it was a gunshot and not another loud noise.
Refine Location with Echo Analysis: Identify reflections of the sound from nearby surfaces and use echo analysis to improve accuracy if needed, by adjusting the triangulation.
Further analyze gunshot characteristics to determine what type of gun and/or what type of ammunition was fired. Results of artificial intelligence or neural network processing of gunshot characteristics may be used.

### Step 6: Action and Alert

Alert System: Once the shooter's location is determined, send the estimated coordinates and sound data to emergency response systems (e.g., via the alarm and communications module 40) and activate or interact with other appropriate modules.

### Step 7: Ongoing Monitoring

Continuous Monitoring: The system continues monitoring for additional shots and updates the shooter's location in real-time if new data is received.

Other examples of algorithms that can be executed or applied by the command center may include a Danger Detection Algorithm:
Step 1: Data Collection from Smart Lighting Network
   Receive Input: The microphones in the LED luminaires capture sounds and transmit them to the command center. Other sensors may provide further data.
   Detect Incident: The command center processes signals such as loud noises (e.g., gunshots) or abnormal activity (e.g., glass breaking, screams, etc.).
   Analyze Audio Patterns: Use predefined sound profiles to differentiate dangerous incidents (e.g., gunshots, explosions) from background noise.
Step 2: Danger Classification.
   Classify Incident: Based on audio pattern analysis and intensity and other sensor input, classify the detected event as a dangerous incident (e.g., an active shooter or fire).
Step 3: Trigger Alarm and Alert System.
   Notify Authorities: If the incident is classified as dangerous, immediately send a notification to the emergency response system.
   Send Alert: Simultaneously notify building occupants using pre-configured alert signals via speakers or visual cues (flashing lights).

A Danger Assessment Algorithm may also be applied, with the following steps, by way of example only:
Step 1: Receive and Aggregate Data
   Collect Sensor Data: Gather data from all luminaires in the smart lighting network, including sound, temperature, and motion sensors.
Step 2: Incident Location Identification
   Locate Incident: Using triangulation algorithms based on sound intensity and time of arrival (TOA), pinpoint the location of the dangerous incident in the building.
Step 3: Risk Assessment
   Assess Danger to Occupants: Evaluate the proximity of the danger to occupants using real-time location data (if available), occupancy sensors, and door monitoring systems. The threat of stampede based on a scenario and current distribution of occupants may be considered and taken into account by evacuation systems.
   Predict Spread: For fires or other non-instantaneous threats, predict the spread of danger using heat or smoke sensors and building layout data. AI systems that have been trained with information about the building and combustible materials therein, the status of doors, etc., may be then analyze the potential spread of a fire. For scenarios involving shooters, AI tools can apply location, past movement, and available routes to consider different paths that the shooter or shooter may take, and consider responses to the various scenarios in other operations such as evacuation actions.
Step 4: Categorize Zones by Risk Level
   Risk Levels: Classify building zones into levels of risk (e.g., high, medium, low) based on the distance from the incident, number of occupants, and exit proximity.

An Evacuation Route Optimization algorithm may also be applied, with the following steps, by way of example only:
Step 1: Input Building Layout and Sensor Data
   Consider Layout Information: Use the building's floor plans, including exit locations and stairwells, along with real-time sensor data such as blocked or unsafe routes.
Step 2: Generate Evacuation Routes.
   Dynamic Path Calculation: Calculate optimal evacuation routes for each building zone, considering the location of the danger, blocked passages, and nearest exits.
   Prioritize Safe Routes: Focus on providing routes that avoid high-risk zones, using data from the danger assessment module.
   Optionally integrate countermeasures into evacuation plans to increase the success of evacuation. For example, creating sounds to frighten or distract a shooter may be employed to may a selected evacuation operation more successful.
Step 3: Adapt Routes in Real-Time.
   Dynamic Adjustments: Continuously update routes based on new information about the location and spread of the danger (e.g., fire moving toward certain exits or predicted route of a shooter).

Lighting guidance to building occupants for evacuation or otherwise reducing risks may be aided with a Lighting Guidance algorithm with the following steps, by way of example only:
Step 1: Modify Light Output Based on Danger Location
   Route Indication: Modify LED light output in a manner that guides occupants towards the safe routes (e.g., green lights for safe exits, red or flashing lights for unsafe areas).
Step 2: Signal Exits and Hazards
   Evacuation Signals: Flash the lights at exits to indicate available, safe pathways. Darken or flash warning lights in areas that are unsafe. Use directional signals such as LED lights forming arrows to point a direction or using color or flashing to warn against dangerous routes.
Step 3: Continuous Feedback
   Monitor Occupant Movement: Use occupancy sensors and motion detection in LED luminaires to track the movement of occupants and ensure that lighting continues to guide them efficiently.

Many variations of these approaches can be considered. By way of example, another useful algorithm could include the following Threat Analysis and Response Algorithm:

### Threat Analysis and Response Algorithm, Step 1: Threat Detection:

Input: Sensor data from microphones, cameras, motion detectors, gunshot detectors, etc.
Analysis:
   Location: Determine whether the threat is indoors, outdoors, or near the building perimeter.
   Type: Classify the nature of the threat (e.g., active shooter, explosion, fire, chemical spill).
   Mobility: Assess if the threat is stationary (e.g., fire, structural damage) or mobile (e.g., an assailant, stampede).
   Containability: Determine if the threat can be contained or sealed off (e.g., a fire in a wing of the building, a shooter outside the building).

### Step 2: Initial Threat Categorization:

Output: Classification of the threat.
   Is the threat confined to a single location?
   Stationary (can it be sealed off or contained?).
   Mobile (is it moving indoors, towards people, or outdoors?).
Is the threat indoors or outdoors?
   Indoors (requires rapid evacuation or lockdown).
   Outdoors (could a barrier or locked doors prevent entry?).
Does the threat require evacuation?
   Yes (determine routes and methods).
   No (shelter in place or seal off threat area).
      Step 3: Decision Tree for Evacuation vs. Shelter-in-Place
Evacuation Criteria:
   Is the threat imminent (e.g., fire, explosion, active shooter near occupants)?
   Are there viable exit routes that avoid the threat?
   Is there a risk of spreading (e.g., fire spreading, shooter advancing)?
Shelter-in-Place Criteria:
   Can the threat be sealed off or avoided without evacuation (e.g., locking doors, blocking off exits)?
   Are there safe zones (e.g., rooms with locked doors, hardened structures) where occupants can stay until the threat is neutralized?

### Step 4: Evacuation Route Planning:

Input: Building layout, location of exits, status of threats.
Output: Real-time optimized evacuation routes.
Safe Exit Calculation:
   Identify available, safe exits based on the proximity of the threat.
   Use lighting cues (e.g., green arrows or flashing LED lights) to indicate safe paths.
Dynamic Updates:
   Continuously adjust evacuation routes based on real-time data about the threat (e.g., if a shooter moves, block certain exits and reroute occupants).

### Step 5: Shelter-in-Place Planning:

Output: Safe zones and lockdown strategy.
Lockdown Protocol:
   Lock doors and entrances in high-risk areas to prevent the threat from reaching occupants.
   Secure rooms with the ability to block the threat.
   Provide instructions to people on what actions to take (e.g., guiding with light cues, text messages, or voice instructions).
Light and Sound Signals:
   Use lights to indicate that people should remain in place (e.g., flashing red lights in high-risk areas, green lights in safe rooms) or guide them to safe locations with directional signals.
   Send audio instructions via public address (PA) systems or mobile notifications.

### Step 6: Countermeasure Activation:

Output: Actions to disrupt or delay the threat.
Distraction Tactics:
   Use flashing lights, strobe effects, and sound distractions (e.g., alarms, sirens) to disorient an attacker.
   Darken areas where threats are detected to impede visibility for assailants.
Physical Barriers:
   Automatically lock doors or gates to contain the threat.
   Activate security systems like bullet-resistant shutters, fire doors, etc.
Active Deterrence:
   If available, deploy drones, robots, or non-lethal countermeasures (e.g., gas, pepper spray, acoustic weapons) to neutralize the attacker or delay their progress.

### Step 7: Communication and Alerts:

Output: Coordinated communication to minimize chaos.
Call Authorities: Notify local police, fire, and medical teams.
Internal Alerts:
   Push notifications to mobile devices within the building.
   Send audio or visual alerts (e.g., alarms, flashing lights, PA announcements) to all occupants.
   Provide instructions for moving or sheltering based on the threat.
External Alerts: Communicate with nearby buildings or public areas if the threat may spread beyond the immediate building or location of concern.

### Step 8: Continuous Monitoring and Adjustment:

Input: Real-time data from sensors, human reports, video analytics.
Output: Adapted strategies based on the evolving situation.
Ongoing Threat Assessment:
   Continuously monitor the threat's position and behavior (e.g., shooter movement or fire spread).
Real-time Adjustment:
   Adjust evacuation routes and sheltering strategies based on new data.
   Update countermeasures and threat responses dynamically (e.g., unlock new exits or reroute people if safe).

### Step 9: Threat Neutralization and Post-Threat Actions:

Output: Once the threat is neutralized, guide recovery efforts.
Guided Return:
   Once the threat is contained, guide occupants back to safe zones using lighting cues or PA announcements.
Emergency Medical Support:
   If injuries are detected, use the system to guide first responders to those in need (e.g., flashing lights over injured individuals or rooms with medical emergencies).
Post-Event Reporting:
   Provide authorities with data on the event, including threat location, response measures, and sensor data for future prevention.
Assessment and Revision:
   Determine where there were gaps in the security system including hardware, command center performance, software, network performance, etc., and determine and pursue upgrades or revisions needed to further enhance safety at the location in question and at other sites using related smart LED lighting systems.

### Electrical Connectors

A wide variety of electrical connectors may be considered for various connections in the LED luminaire, such as wire-to-wire connectors, wire-to-board connectors, and board-to-board connectors. Electrical connectors that may be used include any suitable NEMA connector, including twist-lock connectors such as NEMA L6 (e.g., L6-20P) or L15 (e.g., L15-30P) connectors. See, for example, https://en.wikipedia.org/wiki/NEMA_connector. Suitable connectors may also be selected from the connection products of companies such as Wago, Molex, TE Connectivity, Amphenol, Hirose Electric, Phoenix Contact, etc.

Connectors for a PCB board that may be part of the substrate or otherwise in electrical communication with the LED lights and LED driver may be of any suitable form, such as rail mount plugs, harness style plus, angled connectors, direct marking connectors, snap-on connectors, etc. The “direct marking” connectors are designed to work with pre-printed wire markers, which can be inserted directly into the connector housing to provide identification of the individual wires.

Many examples of suitable connectors are shown, for example, in the catalog of Wago GmbH (Minden, Germany), WAGO PCB Terminal Block and Connectors Full Line Catalog, vol. 2, edition 2021/2022, at https://store-hf5p6bxj3i.mybigcommerce.com/content/wago/catalogs/wago-Full-Line-Catalog-Volume-2-PCB.pdf. Exemplary connections include the 1-conductor female plug MCS MIDI, 722 Series, p. 466, 721 Series, p. 509, and 231 Series, p. 560; 1-conductor male connector MCS MIDI, 721 Series, p. 478; female connector for rail-mount terminal blocks, 722 Series, p. 498; THT male header (harness style), 721 Series, p. 534; Direct Marking MCS MIDI and MCS MIDI Classic male and female connectors, p. 548; THT male header for double-deck assembly, 232 Series, p. 590; PCB connectors and headers, MCS MIDI Classic style, as shown on p. 743, including 1) male headers with angled solder pins, male headers for double-deck assembly, angled female connectors with conductor entry opposite of latches and angled female connector with conductor entry in the same direction as latches; exemplary arrangements as shown on p. 751; 1-conductor female plug, MCS MAXI 16, with level actuation and a push-in Cage Clamp, 832 Series, p. 768; feedthrough terminal blocks, 231, 731 and 226 Series, p . . . 801; and feedthrough terminal block, 828 Series with CAGE CLAMP® lever mounting actuation and locking claw, 16 square millimeters, and 11.5 mm pin spacing, p. 817. All examples are non-limiting.

In one aspect, connectors are used that can permit the LED component chassis to be removed and installed under full electrical load, such that power does not need to be cut prior to mating and unmating of the connectors that provide power to the LEC component chassis from the power source. Suitable connectors for this purpose include Wago Winstra conectors, including those described at https://www.wago.com/us/discover-pluggable-connectors/winsta. Latching and non-latching connectors may be used, though in some aspects non-latching may be helpful.

### Further Network Considerations

In one aspect, a cooperative network is provided to protect a predetermined region, comprising a first network of mobile devices (or predominantly of mobile devices) such as cell phones operating in the region on a first protocol such as a 5G, 6G, LTE, or Wi-Fi network or combination and a second network comprising fixed devices such as stationary LED luminaires equipped with radios and operating on a second protocol. The second network may be a predominately fixed network, that is, one that operates with devices that are predominantly fixed in place or have relatively restricted mobility, such as devices attached to doors or playground equipment that may move along a fixed path but lack the mobility of device carried by a human or a vehicle.

The first protocol and second protocol need not be entirely different, but may, for example, both comprise Wi-Fi or wireless signals of a common or similar frequency. However, in some aspects the two networks may be kept segregated in spite of related communication protocols. For example, when all or parts of the two networks employ Wi-Fi or other similar carriers or protocols that may benefit from segregation, segregation may be achieved by: (1) separate Service Set Identifiers (SSIDs) to define two separate Wi-Fi networks; (2) virtual LANs (VLANs) can be used to partition a single physical network into multiple logical networks, such that even if the devices are connected to the same physical switch or router, they can be isolated from each other; (3) Wi-Fi bands, such as one band at 2.4 GHz for one network and another band at 5 GHz for another network, coupled as needed with other tools to prevent cross-talk between the networks; and (4) network segmentation, which involves splitting a computer network into subnetworks, each being a network segment.

Strategies for network segmentation may include (1) subnetting in which a network is divided into logical sub-networks by manipulating the subnet mask of the network; (2) Virtual Local Area Networks (VLANs) that are used to segment a network at the data link layer (layer 2 of the seven-layer Open Systems Interconnection or OSI model); (3) Access Control Lists (ACLs) to control which devices can communicate with each other on a network (essentially a list of rules that can permit or deny traffic based on various criteria, like IP address or port number); (4) firewalls that segment a network at the network layer (layer 3 of the OSI model) that may block or allow traffic based on rules similar to ACLs, or, for example, inspect the contents of packets to achieve filtering; and (4) Software-Defined Networking (SDN) to provide dynamic, programmable network segmentation, allowing for flexible and efficient network isolation and control.

More than one network may be involved, such as two, three, four, etc., networks. For example, a safety system may employ a first network and a second network, wherein the first network may be a building automation network operating on a Building Automation and Control network (BACnet) protocol while the second network may be a wireless communication network operating on a cellular network protocol, such as the fifth generation (5G) network protocol as well as 6G and any other suitable protocols. Each network may operate using different communication protocols designed for specific applications. For example, the BACnet protocol is typically designed for building automation and control systems, while a 5G network protocol is designed for high-speed wireless communication.

The system may include at least one interface device or server configured to translate communications between diverse protocols such as a BACnet protocol and a 5G network protocol. This interface device may communicate with devices on the BACnet network via a wired connection, and with devices on the 5G network via a wireless connection.

The system may also include a configurable local subnet of the 5G network, comprising a subset of mobile devices operating within or near the building. This subnet is distinct from the broader 5G network, which may extend over a wide geographical area. Communications between the BACnet network and the local subnet are facilitated by the interface device, allowing mobile users within the building to interact with the building automation system.

In one aspect, the network may comprise a wireless network manager, a wireless interface processor, a power consumption monitor, one or more device controllers, one or more system controllers, etc. Illustrative teachings on network structure and operation may be found in U.S. patent application No. 20090150004, “Wireless Building Automation and Control Network,” published Jun. 11, 2009 by L. Wang et al.

In a further aspect, the LED luminaire may comprise a voltage adjusting block (VAB) coupled to an LED panel in communication with the driver, which may be controlled by preset commands, or commands provided by wired or wireless signals.

### Further Remarks

In describing various aspects herein, it should be understood that every aspect or variation of each feature, element, method, process, system, and so forth, may be combined when feasible and suitable with any other such feature, element, method, process, system, and so forth. Thus, unless an inoperable or contradictory result is obtained, a description of one aspect of an article or method comprising elements A and B, and a description of another aspect of said article or method comprising elements C and D, may be understood to also support claims for the article of method comprising: (1) A and B, (2) C and D, (3) A, B, C, and D, or (4) and combination of A, B, C, and D.

When introducing elements of aspects of the invention or the embodiments thereof, the articles “a,” “an,” “the,” and “said” are intended to mean that there are one or more of the elements, and thus may include plural referents unless the context clearly dictates otherwise. The terms “comprising,” “including,” and “having” are intended to be inclusive and mean that there may be additional elements other than the listed elements.

As used herein, the word “exemplary” means serving as an example, instance, or illustration. The aspects described herein are not limiting but rather are exemplary only. It should be understood that the described aspects are not necessarily to be construed as preferred or advantageous over other aspects. Unless otherwise indicated, no aspect of any invention described herein should be assumed to have the same advantages or features had by any other aspect.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less” and “greater”, are intended to encompass the concept of equality. As an example, “less” can mean not only “less” in the strictest mathematical sense, but also, “less than or equal to.”

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

While the foregoing description makes reference to particular illustrative aspects, these examples should not be construed as limitations. The inventive system, methods, and products can be adapted for other uses or provided in other forms not explicitly listed above, and can be modified in numerous ways within the spirit of the present disclosure. Thus, the present invention is not limited to the disclosed aspects, but is to be accorded the widest scope consistent with the claims below.

We claim:

1. A smart LED lighting system, comprising:
(1) an array of LED luminaires, each LED luminaire comprising a component chassis having an LED light panel and a driver for controlling light output from the LED light panel, the component chassis also being connected to a microphone, and also connected to a communication device for sending and receiving information, the array of LED luminaires forming a smart lighting network; and
(2) a command center adapted to communicate with the smart lighting network, the command center comprising an analytics module for assessing the danger to occupants throughout a building in response to detection of a dangerous incident, and an evacuation module for guiding occupants to pursue a safe route; wherein in response to detection of a dangerous incident based on information provided by the smart lighting network, the command center directs the smart lighting network to modify its light output to assist in evacuating occupants.

2. The smart LED lighting system of claim 1, adapted to modify the light output of one or more luminaires in response to detection of a dangerous incident to display a lighting pattern indicating a direction of travel to pursue.

3. The smart LED lighting system of claim 2, adapted to also modify the color of the light output of one or more luminaires in response to detection of a dangerous incident to display an indication of danger.

4. The smart LED lighting system of claim 1, wherein one or more luminaires comprises a microprocessor configured to analyze a sound signal captured by the microphone and determine if the sound is indicative of a gunshot.

5. The smart LED lighting system of claim 4, further having access to a database of gunshot characteristics for specific types of guns or ammunition, wherein the microprocessor is adapted to compare a gunshot sound to the database to determine what type of gun or ammunition has been discharged.

6. The smart LED lighting system of claim 5, wherein the command center has access to a database of gunshot characteristics for specific types of guns or ammunition, and has a processor adapted to compare a gunshot sound to the database to determine what type of gun or ammunition has been discharged.

7. The smart LED lighting system of claim 6, wherein the command center further comprises a training module for training occupants of the building in how to escape safely in response to a hazard guided by the modified light output of the LED luminaires.

8. The smart LED lighting system of claim 1, wherein one or more of the LED luminaires comprises a component chassis having a processor and memory having a database of gunshot related data, wherein the processor is adapted to analyze the characteristics of a gunshot sound and to identify the weapon or the ammunition used, based on comparison of the characteristics of the gunshot sound with the database of gunshot related data.

9. The smart LED lighting system of any of claim 1, adapted to cooperate with an exterior gunshot detection system, whereby the exterior gunshot detection system is adapted to alert the command center of the nearby danger.

10. The smart LED lighting system of any of claim 1, further comprising a dual band network, with one band adapted for control and monitoring of a lighting network and one band adapted for emergency response.

11. A method for evacuating the inhabitants of a building in response to a sound indicative of a dangerous incident, the method comprising the steps of:
a) providing a building with a smart lighting network comprising an array of LED luminaires each comprising a power source, an LED driver connected to the power source, a microphone electrically connected to the LED driver, a processor and an associated memory in communication with the microphone, an LED panel operatively associated with the LED driver an adapted to provide a variety of light outputs as directed by the LED driver, a communication device in communication with the processor, wherein the LED luminaires of the array communicate to form a smart lighting network; and
b) monitoring ambient sound via the microphones of the smart lighting network for a sound with a sound pressure above a predetermined threshold, and when the threshold is exceeded, analyzing the sound using at least one of the processors of the smart lighting network according to instructions recorded in the associated memory to determine if the characteristics of the sound are likely those of a gunshot, and in response to detection of a likely gunshot, modifying the light output at least one of the luminaires to indicate a state of danger and modifying the light output of plurality of luminaires to indicate an evacuation route.

12. The method of claim 11, wherein the step of modifying the light output is carried out in response to directions issued by the processor.

13. The method of claim 11, further comprising communication between the smart lighting network and a command center adapted to communicate with smart lighting network, the command center comprising an analytics module for assessing the danger to occupants throughout a building in response to detection of a dangerous incident, and an evacuation module for guiding occupants to pursue a safe route; wherein in response to detection of a dangerous incident based on information provided by the smart lighting network, the command center directs the smart lighting network to modify its light output to assist in evacuating occupants.

14. The method of claim 13, further comprising communication the detection of the gunshot with the command center.

15. The method of claim 13, wherein the step of modifying the light output is carried out in response to directions issued by the command center.

16. The method of claim 13, wherein the command center has access to a database of gunshot characteristics for specific types of guns or ammunition, and has a processor adapted to compare a gunshot sound provided by the smart lighting network to the database to determine what type of gun or ammunition has been discharged.

17. The method of claim 13, wherein the command center further comprises a training module for training occupants of the building in how to escape safely in response to a hazard guided by the modified light output of the LED luminaires.

18. The method of claim 13, wherein the command center comprises a countermeasures module capable of directing actions against an assailant selected from the group comprising increasing or decreasing light intensity provide by the smart lighting network, automatically locking doors, activating one or more drones to approach the assailant, and delivering a chemical or other material to impede the assailant.

19. The method of claim 11, wherein the array of LED luminaires comprises a plurality of microphones, each associated with a respective LED luminaire and the microphone having an AOP of at least 130 dB and a diameter of less than 20 mm.

20. The method of claim 11, wherein the array of LED luminaires comprises an LED luminaire electrically connected to at least one of the group consisting of a motion detector, a camera, an IR sensor, an accelerometer, and a flash detector.
